(19) United States
(12) Patent Application Publication
(10) Pub. No.: US 2026/0290294 A1
(43) Pub. Date: Sep. 24, 2026

(54) STRING INSTRUMENT

(71) Applicant: Yamaha Corporation, Hamamatsu (JP)

(72) Inventors: Masao NORO, Hamamatsu (JP); Hiroshi HONDA, Toyohashi (JP); Shoji TOKUNAGA, Hamamatsu (JP); Yuta SHINJI, Hamamatsu (JP)

(21) Appl. No.: 19/684,159

(22) Filed: May 21, 2026

Related U.S. Application Data
(63) Continuation of application No. PCT/JP2024/041437, filed on Nov. 22, 2024.

(30) Foreign Application Priority Data
Nov. 22, 2023 (JP) 2023-198322

(51) Int. Cl. G10H 1/34

(52) U.S. Cl. CPC G10H 1/342

(57) ABSTRACT

A string instrument includes a neck, a plurality of frets that are conductive and arranged, along the neck, with an interval between adjacent frets of the plurality of frets, a plurality of strings that are conductive and are configured to contact one or more of the plurality of frets, a plurality of drive coils corresponding to the plurality of frets, respectively, a signal supply unit configured to supply a drive signal to each of the plurality of drive coils, a feedback line connected to each of the plurality of frets, and a voltage detector configured to detect a first detection voltage between the feedback line and a first string of the plurality of strings during a period in which the drive signal is supplied to each of the plurality of drive coils.

### CROSS-REFERENCE TO RELATED APPLICATIONS

This application is a continuation application of International Application No. PCT/JP 2024/041437, filed on Nov. 22, 2024, which claims priority to Japanese Patent Application No. 2023-198322 filed in Japan on Nov. 22, 2023. The entire disclosures of International Application No. PCT/JP2024/041437 and Japanese Patent Application No. 2023-198322 are hereby incorporated herein by reference.

### BACKGROUND

### Technical Field

This disclosure generally relates to a string instrument.

### Background Information

Techniques have been proposed in the prior art for analyzing the position of each string of a string instrument that has been fretted by a performer. For example, Japanese Unexamined Utility Model Application Publication No. H4-85394 discloses a technique for using coils that are disposed for each fret on the surface of the neck of an electric string instrument to detect the fretting position. In the configuration of Japanese Unexamined Utility Model Application Publication No. H4-85394, voltage pulses are sequentially supplied to each of a plurality of strings, and the induced voltage generated in each coil as a result of application of the voltage pulses is detected to identify the fretting position.

### SUMMARY

In the configuration of Japanese Unexamined Utility Model Application Publication No. H4-85394, a large current occurs in each string due to the supply of voltage pulses. Accordingly, the current of each string may impact the operation (pickup) by which vibrations generated in the strings by a performance are magnetically detected. In consideration of such circumstances, an object of one aspect of the present disclosure is to detect fretting positions while suppressing impact on the detection of vibrations in the strings of a string instrument.

A string instrument according to one aspect of this disclosure includes a neck, a plurality of frets that are conductive and arranged, along the neck, with an interval between adjacent frets of the plurality of frets, a plurality of strings that are conductive and are configured to contact one or more of the plurality of frets, a plurality of drive coils corresponding to the plurality of frets, respectively, a signal supply unit configured to supply a drive signal to each of the plurality of drive coils, a feedback line connected to a first string of the plurality of strings, and a voltage detector configured to detect a first detection voltage between the feedback line and the first string during a period in which the drive signal is supplied.

### BRIEF DESCRIPTION OF THE DRAWINGS

FIG. 1 is a plan view of an electric bass according to a first embodiment.

FIG. 2 is an explanatory diagram of the principle for detecting a fretting position.

FIG. 3 is an explanatory diagram of the principle for detecting a fretting position.

FIG. 4 is an explanatory diagram of the principle for detecting a fretting position.

FIG. 5 is an enlarged plan view of a portion of a fingerboard.

FIG. 6 is a plan view of a neck.

FIG. 7 is a cross-section diagram taken along line VII-VII in FIG. 5.

FIG. 8 is a cross-section diagram taken along line VIII-VIII in FIG. 5.

FIG. 9 is an explanatory diagram of the relationship between a feedback line and each string in the first embodiment.

FIG. 10 is an explanatory diagram of the relationship between feedback lines and each string in a second embodiment.

FIG. 11 is a block diagram showing a configuration of a detection device.

FIG. 12 is an explanatory diagram of an operation of a signal supply unit.

FIG. 13 is a circuit diagram for supplying a drive signal to each drive coil.

FIG. 14 is a circuit diagram showing a configuration of a voltage detection unit.

FIG. 15 is an explanatory diagram relating to drops in detection voltage due to fretting of a plurality of strings.

FIG. 16 is an explanatory diagram of reference voltage.

FIG. 17 is an explanatory diagram of difference voltage between detection voltage and reference voltage.

FIG. 18 shows a transient response of an amplifier.

FIG. 19 is an explanatory diagram of the principle for detecting a fretting position according to a third embodiment.

FIG. 20 is an explanatory diagram of the principle for detecting a fretting position according to the third embodiment.

FIG. 21 is an explanatory diagram of the principle for detecting a fretting position according to the third embodiment.

FIG. 22 is a block diagram illustrating a configuration of a detection device according to the third embodiment.

FIG. 23 is a block diagram illustrating configurations of a signal output unit and a fretting analysis unit.

FIG. 24 is a schematic diagram of detection data.

FIG. 25 is a schematic diagram of temporal changes in the voltage of each string.

FIG. 26 is a part of a flowchart of a fretting analysis process.

FIG. 27 is another part of the flowchart of the fretting analysis process.

FIG. 28 is a block diagram illustrating configurations of a signal output unit and a fretting analysis unit according to a fourth embodiment.

FIG. 29 is a cross-section diagram showing the relationship between a connection part and a fret according to a fifth embodiment.

FIG. 30 is a cross-section diagram of the neck according to a modified example of the fifth embodiment.

FIG. 31 is a cross-section diagram of the neck according to a modified example of the fifth embodiment.

FIG. 32 is a block diagram illustrating a configuration of a signal processing unit according to a modified example.

FIG. 33 is a cross-section diagram of the neck according to a modified example of the first embodiment.

### DETAILED DESCRIPTION OF THE EMBODIMENTS

### A: First Embodiment

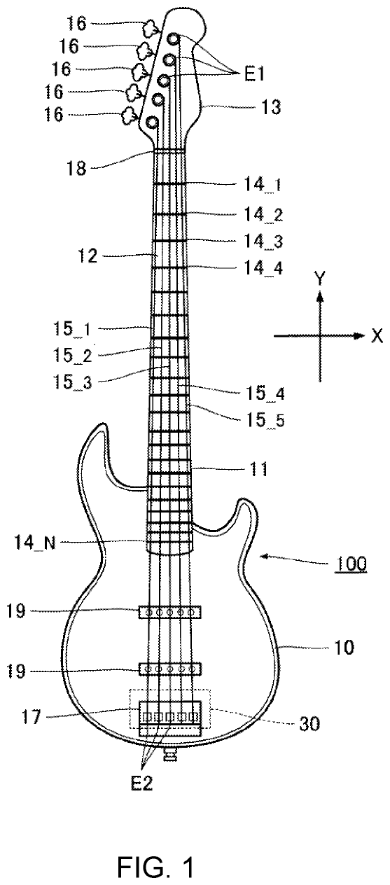

FIG. 1 is a plan view of an electric bass 100 according to the first embodiment. The electric bass 100 is a string instrument including a body 10, a neck 11, a fingerboard 12, a head 13, a plurality of (N) frets 14_1 to 14_N, five strings 15_1 to 15_5, and a detection device 30. The body 10 is a structure that supports each element of the electric bass 100. In the following description, X and Y axes are assumed, which are orthogonal to each other.

Each of the five strings 15_1 to 15_5 is a linear conductor that includes a first end E1 and a second end E2. The material of each string 15_m (m=1 to 5) can be freely selected. The neck 11 is an elongated member extending along the Y axis. That is, the Y axis is an axis along the direction in which the neck 11 extends. The proximal end of the neck 11 located in the negative direction of the Y axis is fixed to the body 10. A head 13 is installed at the distal end of the neck 11 located in the positive direction of the Y axis. Five pegs 16 each corresponding to a different string 15_m are installed in the head 13. The first end E1 of each string 15_m is fixed to the peg 16. A bridge 17 to which the second end E2 of each string 15_m is fixed is installed on the body 10.

The fingerboard 12 is an elongated plate-like member installed on the neck 11. The fingerboard 12 is located between the five strings 15_1 to 15_5 and the neck 11. Each of the strings 15_m faces the surface of the fingerboard 12 with a gap between each of the strings 15_m and the surface of the fingerboard 12. The N frets 14_1 to 14_N are conductive members installed on the surface of the fingerboard 12. Specifically, the N frets 14_1 to 14_N are arranged in the Y-axis direction spaced apart from each other, and an interval exists between two adjacent frets that are adjacent in the Y-axis direction. Each fret 14_n (n=1 to N) is an elongated member that extends in the X-axis direction over the entire width of the fingerboard 12, and that protrudes from the surface of the fingerboard 12. The fret 14_1 located at one end of the arrangement of the N frets 14_1 to 14_N is closest to the head, and the fret 14_N located at the other end of the arrangement is closest to the bridge 17.

A nut 18 is installed at the end of the fingerboard 12 near the head 13. The five strings 15_1 to 15_5 are stretched between the nut 18 and the bridge 17 with a prescribed tensile force. Specifically, the five strings 15_1 to 15_5 extend in the Y-axis direction, spaced apart from each other in the X-axis direction. Any one string 15_m1 (m1=1 to 5) among the five strings 15_1 to 15_5 is one example of the “first string”, and one string 15_m2 (m2=1 to 5, m1≠m2) different from the string 15_m1 is one example of the “second string.” The nut 18 is formed of an insulating material, for example, but can be formed of a conductive material in a case where the nut 18 is configured so as not to come in contact with a feedback line 22, described further below.

Each of the five strings 15_1 to 15_5 is located away from the N frets 14_1 to 14_N in a released state of not being fretted by a performer. Each of the strings 15_m can contact one or more of the N frets 14_1 to 14_N by being fretted by the performer. Fretting is a performance operation in which each of the strings 15_m is pressed toward the fingerboard 12. The performer can fret any position of a desired string 15_m within the range of the fingerboard 12.

A plurality of pickups 19 are installed on the body 10. Each of the pickups 19 detects vibrations generated in the strings 15_m by the performer's performance (specifically, picking) and generates an audio signal corresponding to the vibrations. The audio signal generated by each of the pickups 19 is processed by an audio device (not shown), such as an amplifier, and then reproduced as sound waves.

The detection device (detector) 30 detects, for each of the five strings 15_1 to 15_5, presence or absence of fretting by the performer as well as the position of fretting by the performer (hereinafter referred to as “fretting position”). Specifically, for example, from among the N frets 14_1 to 14_N, one or more of the frets 14_n contacting the strings 15_m are detected for each of the strings 15_m as the fretting positions. FIG. 1 shows a configuration in which the detection device 30 is built into the body 10, but the detection device 30 can be configured separately from the electric bass 100 and be connected to the electric bass 100.

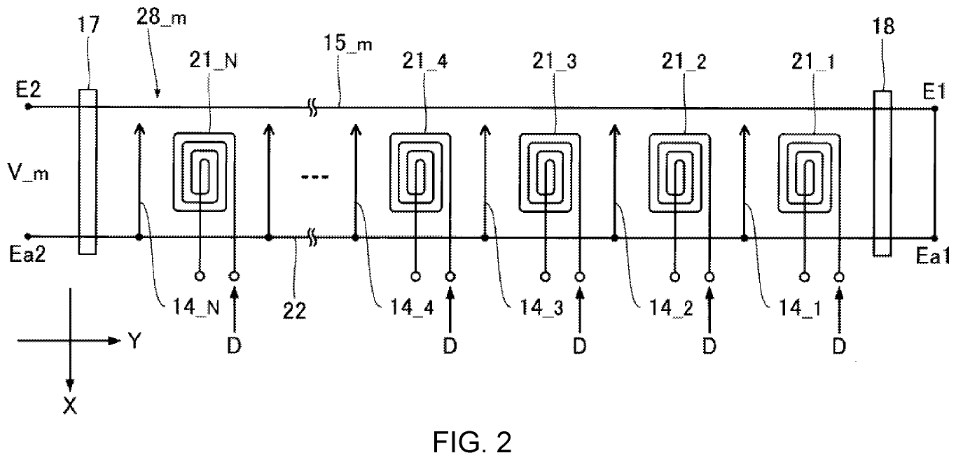

FIG. 2 is an explanatory diagram of the principle for detecting the fretting position for any one string 15_m. The electric bass 100 includes N drive coils 21_1 to 21_N corresponding to the N frets 14_1 to 14_N, respectively. The drive coil 21_n is positioned between two adjacent frets 14_n and 14_n−1. As described above, one of the N drive coils 21_1 to 21_N is installed in each of the intervals between the N frets 14_1 to 14_N.

A feedback line 22 in FIG. 2 is a linear wiring having a first end Ea1 and a second end Ea2, and extends in the Y-axis direction spaced apart from each of the strings 15_m. The first end Ea1 is the end of the feedback line 22 located in the positive direction of the Y axis, and the second end Ea2 is the end of the feedback line 22 located in the negative direction of the Y axis. The feedback line 22 is electrically connected to the strings 15_m. Specifically, the feedback line 22 is connected to the portion of the string 15_m located further in the positive direction of the Y axis (that is, on the distal end side of the neck 11) than the N frets 14_1 to 14_N. For example, the first end E1 of the string 15_m is connected to the feedback line 22. Accordingly, the string 15_m and the feedback line 22 constitute a single-turn coil (hereinafter referred to as “detection coil 28m”). In addition, each of the N frets 14_1 to 14_N is electrically connected to the feedback line 22.

A drive signal D is sequentially supplied on a time-division basis to each of the N drive coils 21_1 to 21_N. The drive signal D is a periodic signal in which the signal level fluctuates periodically. In response to the drive signal D being supplied and a current flowing through a drive coil 21_n (primary coil), an electromotive force is generated in a detection coil 28_m (secondary coil) including the string 15_m and the feedback line 22 by mutual induction caused by a magnetic field that is generated in the drive coil 21_n. In the first embodiment, the detection voltage V_m is detected between the string 15_m and the feedback line 22, and the fretting position is identified in accordance with the detection voltage V_m. The detection voltage V_m is the voltage between the second end E2 of the string 15_m located further in the negative direction of the Y axis (that is, on a side of the proximal end of the neck 11) than the N frets 14_1 to 14_N, and the second end Ea2 of the feedback line 22 located in the negative direction of the Y axis.

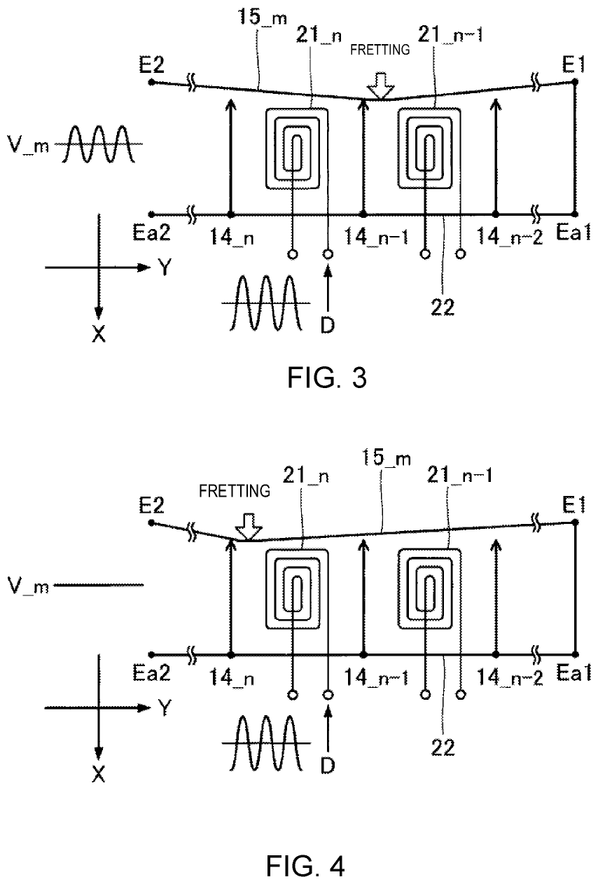

FIGS. 3 and 4 show the frets 14_n and 14_n−1 adjacent to each other with the drive coil 21_n sandwiched between the frets 14_n and 14_n−1. A state in which the drive signal D is supplied to the drive coil 21_n is assumed.

As shown in FIG. 3, in a cases where a portion of the string 15_m between frets 14_n−1 and 14_n−2 is fretted, the fret 14_n−1 located further in the positive direction of the Y axis than the drive coil 21_n to be driven comes into contact with the string 15_m. Accordingly, in response to the drive signal D being supplied to the drive coil 21_n, electromotive force is generated in the detection coil 28_m including the string 15_m, the fret 14_n−1, and the feedback line 22. Accordingly, the detection voltage V_m fluctuates periodically in the same manner as the drive signal D. Similarly, the detection voltage V_m fluctuates periodically in a state in which the string 15_m is released.

On the other hand, as shown in FIG. 4, in a cases where a portion of the string 15_m between the frets 14_n and 14_n−1 is fretted, the fret 14_n located further in the negative direction of the Y axis than the drive coil 21_n to be driven comes into contact with the string 15_m. Accordingly, in response to the drive signal D being supplied to the drive coil 21_n, the voltage (detection voltage V_m) of the detection coil 28_m essentially does not fluctuate.

As described above, the detection voltage V_m during the period (supply period T_n, described further below) in which the drive signal D is supplied to each of the drive coils 21_n changes in accordance with the fretting position of the string 15_m. Accordingly, the fretting position of the string 15_m can be identified using the detection voltage V_m in response to the drive signal D being sequentially supplied to each of the N drive coils 21_1 to 21_N. Note that the detection voltage V_m fluctuates periodically in a state in which the string 15_m is released (state in which no position of the string 15_m is being fretted).

As described above, in the first embodiment, an electromotive force is generated in the detection coil 28_m, which includes the string 15_m and the feedback line 22, by mutual induction caused by the supply of the drive signal D to the drive coil 21_n. Then, the fretting position of each of the strings 15_m is identified by detecting the detection voltage V_m between each of the strings 15_m and the feedback line 22. Accordingly, compared to a configuration in which electromotive force is generated in the drive coil 21_n by the supply of the drive signal D to the string 15_m, the current flowing through the string 15_m is reduced. According to the configuration described above, presence/absence as well as the position of fretting of each of the strings 15_m can be detected with high speed and accuracy while suppressing impact on the operation of the pickup 19 detecting the vibrations that are generated in the strings 15_m due to the performance.

In addition, in the first embodiment, as described above, the first end E1 of each of the strings 15_m and the first end Ea1 of the feedback line 22 are connected, and the voltage between the second end E2 of each of the strings 15_m and the second end Ea2 of the feedback line 22 is detected as the detection voltage V_m. Accordingly, it is possible to detect contact of each of the strings 15_m with any of the N frets 14_1 to 14_N across the entire length of the neck 11 in the Y-axis direction.

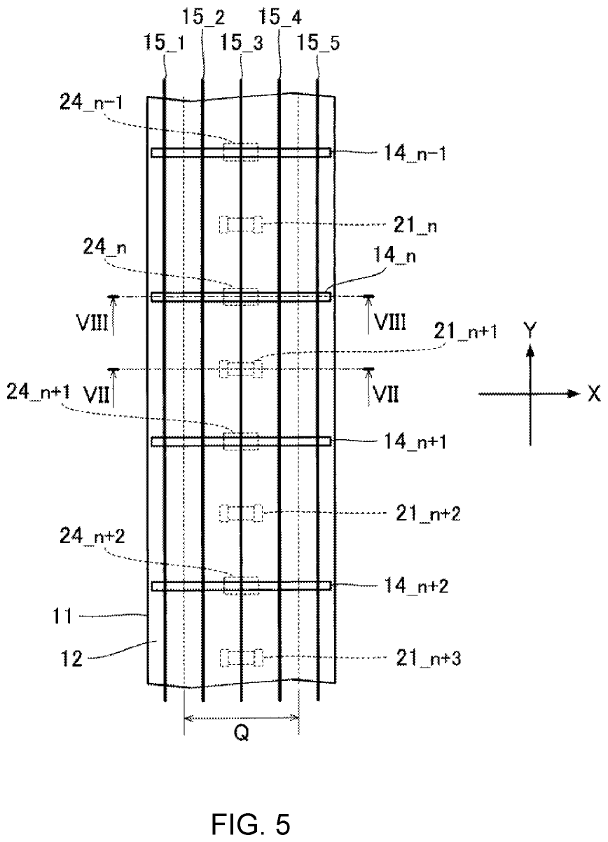

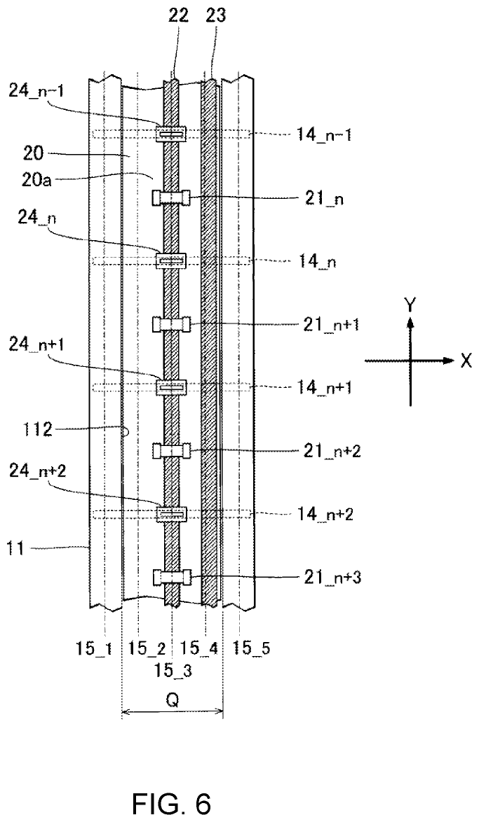

FIG. 5 is an enlarged plan view of a portion of the fingerboard 12. FIG. 6 is a plan view of the neck 11, with the five strings 15_1 to 15_5 and the fingerboard 12 in FIG. 5 removed. As illustrated in FIGS. 5 and 6, as viewed from a direction perpendicular to the surface of the fingerboard 12 (hereinafter referred to as “in plan view”), the drive coils 21_n are installed between each of the frets 14_n and 14_n−1.

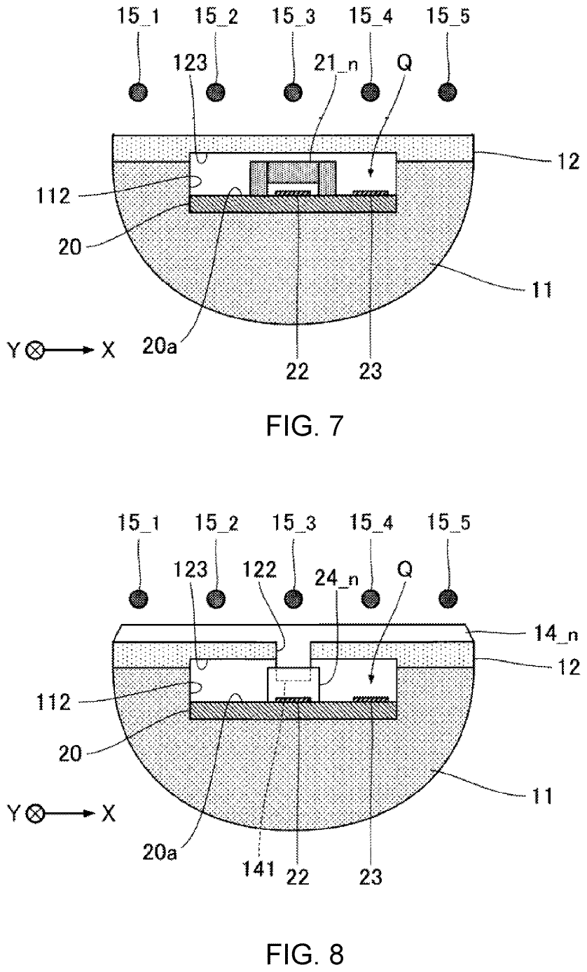

FIG. 7 is a cross-section diagram taken along line VII-VII in FIG. 5, and FIG. 8 is a cross-section diagram taken along line VIII-VIII in FIG. 5. As illustrated in FIGS. 6 to 8, a groove 112 is formed on a surface of the neck 11 facing the fingerboard 12, and a groove 123 is formed on a surface of the fingerboard 12 facing the neck 11.

The grooves 112 and 123 are elongated recesses that extend along the Y axis. A space (hereinafter referred to as “housing space Q”) surrounded by the inner surface of the groove 112 and the inner surface of the groove 123 is formed between the neck 11 and the fingerboard 12. The housing space Q is an elongated space extending along the Y axis over the entire length of the neck 11 in the Y-axis direction. Note that the housing space Q can include either the groove 112 or the groove 123. That is, one of the grooves 112 and 123 can be omitted.

A wiring substrate 20 is housed in the housing space Q. That is, the wiring substrate 20 is installed between the neck 11 and the fingerboard 12. The wiring substrate 20 is an elongated plate-like member extending along the Y axis over the entire length of the neck 11 in the Y-axis direction. The wiring substrate 20 is a mounting component in which a plurality of wirings are formed inside and on the surface of an insulating substrate. For example, a multilayer substrate in which a plurality of insulating layers and a plurality of conductive layers are alternately stacked is used as the wiring substrate 20.

The N drive coils 21_1 to 21_N, N connection parts 24_1 to 24_N, the feedback line 22, and a reference line 23 are installed on the surface of the wiring substrate 20 that faces the fingerboard 12 (hereinafter referred to as “mounting surface 20a”). The feedback line 22 and the reference line 23 are wirings that extend in the Y-axis direction across the entire area of the wiring substrate 20 in the Y-axis direction, and are formed as conductive patterns on the mounting surface 20a, for example.

As described above, the feedback line 22 is a wiring that extends linearly in the Y-axis direction from the first end Ea1 to the second end Ea2. The feedback line 22 is installed near the center of the mounting surface 20a of the wiring substrate 20 in the X-axis direction. That is, the feedback line 22 extends along the center line of the wiring substrate 20. As can be understood from FIGS. 7 and 8, the fingerboard 12 is located between the strings 15_m and the feedback line 22.

The reference line 23 is a dummy string that does not directly contribute to the performance of the electric bass 100. Similar to the feedback line 22, the reference line 23 is a wiring that extends linearly in the Y-axis direction. The reference line 23 is installed on the mounting surface 20 a, spaced apart from the feedback line 22. Specifically, the reference line 23 is formed along an edge of the wiring substrate 20 located in the positive direction of the X axis.

The N drive coils 21_1 to 21_N are arranged in the Y-axis direction spaced apart from each other. As illustrated in FIGS. 6 and 7, each of the drive coils 21_n is, for example, a chip coil mounted on the mounting surface 20a. Each of the drive coils 21_n is installed in the center of the wiring substrate 20 in the X-axis direction. Accordingly, each of the drive coils 21_n overlaps with the feedback line 22 in plan view. Specifically, each of the drive coils 21_n is bonded to the mounting surface 20a so as to straddle the feedback line 22. That is, the N drive coils 21_1 to 21_N are located between the fingerboard 12 and the feedback line 22. According to the configuration described above, the N drive coils 21_1 to 21_N are not exposed to the outside of the electric bass 100. Accordingly, the drive coils 21_n can be installed while maintaining the external appearance of the fingerboard 12.

As illustrated in FIG. 6, the N connection parts 24_1 to 24_N are arranged in the Y-axis direction spaced apart from each other. Specifically, each of the connection parts 24_n is installed in the center of the wiring substrate 20 in the X-axis direction. Accordingly, each of the connection parts 24_n overlaps with the feedback line 22 in plan view. Each of the connection parts 24_n is a clasp or a connection terminal that is electrically connected to the feedback line 22.

The N connection parts 24_1 to 24_N correspond to the fret 14_1 to 14_N, respectively. Each of the connection parts 24_n overlaps with the fret 14_n corresponding to the connection part 24_n in plan view. Accordingly, each of the connection parts 24_n is located between two adjacent drive coils 21_n and 21_n−1.

As illustrated in FIG. 8, each of the frets 14_n has a projecting portion 141. The projecting portion 141 protrudes toward the neck 11 from a portion of the fret 14_n that extends in the X-axis direction. On the other hand, mounting holes 122 corresponding to the frets 14_1 to 14_N, respectively, are formed on the fingerboard 12. Each of the mounting holes 122 is a through-hole that penetrates the fingerboard 12. The projecting portion 141 of each fret 14_n is inserted into the mounting hole 122, thereby penetrating the fingerboard 12. The distal end of the projecting portion 141 of each fret 14_n is connected to the connection part 24_n in the housing space Q. That is, each of the connection parts 24_n is connected to the projecting portion 141 of the fret 14_n corresponding to the connection part 24_n. A plurality of the projecting portions 141 can be formed on one fret 14_n.

As described above, each of the N frets 14_1 to 14_N is electrically connected to the feedback line 22 via the connection part 24_n corresponding to the fret 14_n. According to the configuration described above, each fret 14_n and the feedback line 22 can be electrically connected by a simple configuration that does not require wiring. On the other hand, the reference line 23 does not contact any of the N frets 14_1 to 14_N.

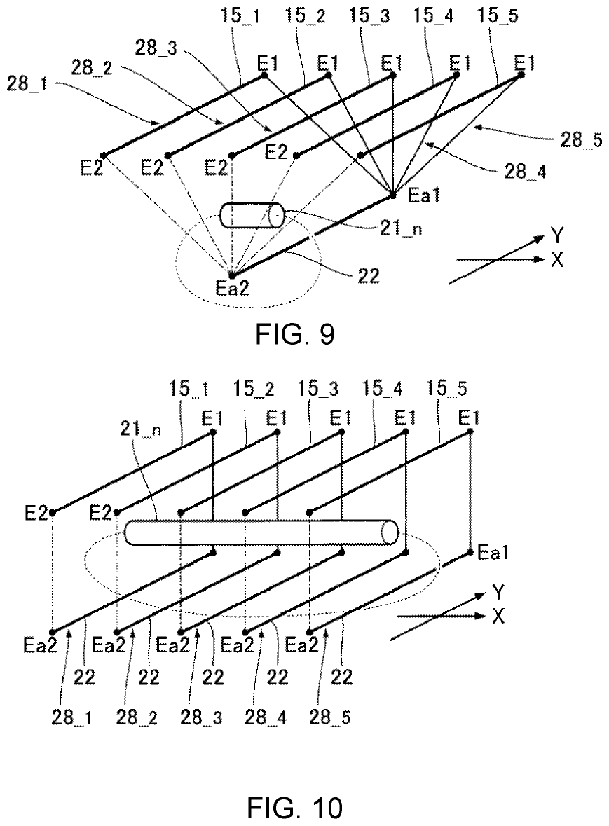

FIG. 9 is an explanatory diagram of the relationship between the five strings 15_1 to 15_5, the feedback line 22, and each of the drive coils 21_n. The five strings 15_1 to 15_5 are connected to one feedback line 22. Specifically, as described above, an end (first end E1) of each of the strings 15_m located in the positive direction of the Y axis is connected to an end (first end Ea1) of the feedback line 22 located in the positive direction of the Y axis.

As described above, in the first embodiment, the mutual induction between each of the drive coils 21_n and the detection coil 28_m that includes the string 15_m and the feedback line 22 is utilized. That is, magnetic flux that is generated in each of the drive coils 21_n by the supply of the drive signal D is interlinked with the detection coil 28_m that includes each of the strings 15_m and the feedback line 22.

As described above, the magnetic flux generated in one of the drive coils 21_n is interlinked with the detection coil 28_m that includes each of the five strings 15_1 to 15_5. That is, the drive coil 21_n is shared for the detection of the fretting position of each of the five strings 15_1 to 15_5. Accordingly, compared to a configuration in which the drive coil 21_n is installed separately for each of the strings 15_m, the configuration of the electric bass 100 can be simplified by reducing the number of the drive coils 21_n. A detection coil 28_m1 is one example of the “first detection coil” and a detection coil 28_m2 is one example of the “second detection coil.”

FIG. 10 is a schematic diagram of a configuration (hereinafter referred to as “second embodiment”) in which the feedback line 22 is separately installed for each of the five strings 15_1 to 15_5. Each of the strings 15_m is connected to a separate feedback line 22 to form the detection coil 28_m. That is, in the second embodiment, five detection coils 28_m, each corresponding to a different string 15_m, are arranged side by side at intervals in the X-axis direction. In the first embodiment, since the five strings 15_1 to 15_5 are connected to the feedback line 22, compared to the second embodiment, the configuration of the electric bass 100 can be simplified by reducing the number of the feedback lines 22.

In the second embodiment, it is necessary to form each of the drive coils 21_n in a shape that is elongated in the X-axis direction so that the magnetic flux of each of the drive coils 21_n interlinks with the five detection coils 28_m. Specifically, for example, the drive coil 21_n needs to have a dimension spanning the entire width of the fingerboard 12.

In contrast to the second embodiment, in the first embodiment, the five strings 15_1 to 15_5 are connected to one feedback line 22. In the configuration described above, as can be understood from FIG. 9, the five detection coils 28_m corresponding to different strings 15_m are in close proximity to each other in the vicinity of the feedback line 22. Accordingly, even in a case where the dimension of the drive coil 21_n in the X-axis direction is small, it is possible to cause the magnetic flux of the drive coil 21_n to be interlinked with the five detection coils 28_m. That is, it is possible to reduce the size of the drive coils 21_n that is required to magnetically couple the detection coil 28_m corresponding to each of the strings 15_m to each of the drive coils 21_n.

In the description above, the second embodiment is illustrated for the purpose of comparison with the first embodiment, but the second embodiment is not excluded from the scope of the present disclosure. The configuration of the second embodiment is also naturally included within the scope of the present disclosure. That is, in the present disclosure, the feedback line 22 can be separately installed for each of the five strings 15_1 to 15_5, and the detection coil 28_m can be separately configured for each of the strings 15_m by the connection of each of the strings 15_m and each of the feedback lines 22. Note that, in the second embodiment, configurations other than the feedback lines 22 being installed for each of the strings 15_m are the same as those of the first embodiment.

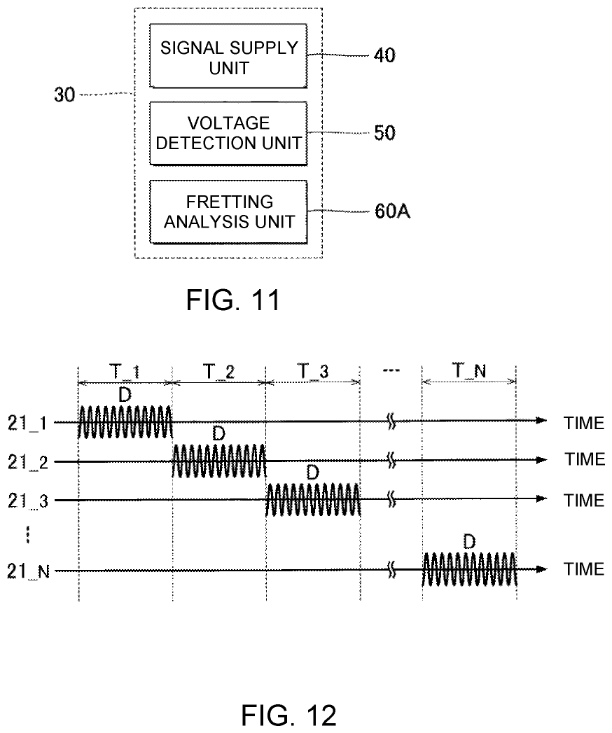

FIG. 11 is a block diagram showing a configuration of the detection device 30. The detection device 30 includes a signal supply unit 40, a voltage detection unit (voltage detector) 50, and a fretting analysis unit 60A. The signal supply unit 40 supplies the drive signal D to each of the N drive coils 21_1 to 21_N.

FIG. 12 is an explanatory diagram of an operation of supplying the drive signal D to each of the drive coils 21_n. As illustrated in FIG. 12, the operation of supplying the drive signal D to each of the N drive coils 21_1 to 21_N is repeated, with N supply periods T_1 to T_N on the time axis serving as one cycle. Each supply period T_n is a period of a prescribed length. The drive signal D is supplied to one of the drive coils 21_n during one supply period T_n. That is, the drive signal D is supplied on a time-division basis to each of the N drive coils 21_1 to 21_N at each supply period T_n.

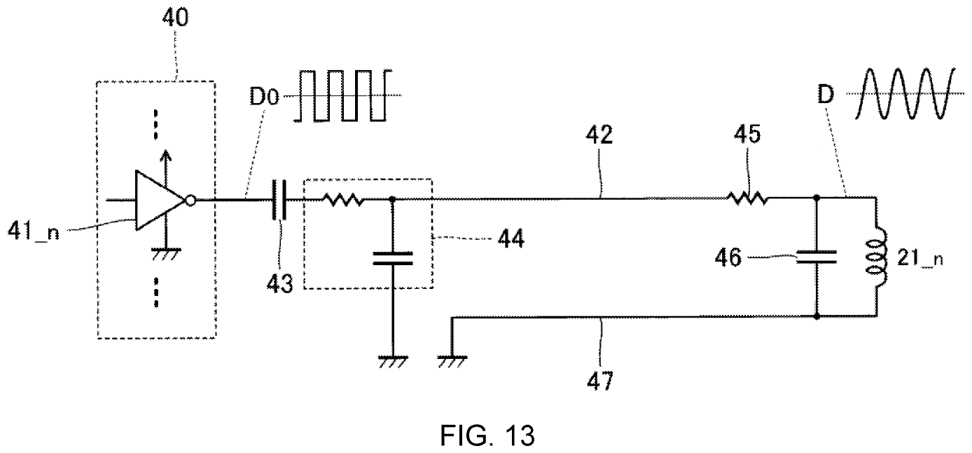

FIG. 13 is a circuit diagram of a configuration for supplying the drive signal D to one of the drive coils 21_n from among the N drive coils 21_1 to 21_N. The configuration of FIG. 13 is installed for each of the N drive coils 21_1 to 21_N.

The signal supply unit 40 includes N drive circuits 41_1 to 41_N corresponding to the drive coils 21_1 to 21_N, respectively. Each of the drive circuits 41_n outputs a drive signal D0 whose voltage fluctuates periodically. The drive circuit 41_n is an inverter circuit that includes a logic circuit, for example.

The drive signal D0 is a square wave whose voltage fluctuates at frequency F0. For example, the frequency F0 is a frequency within a prescribed range that includes 2 MHz (for example, 1.5 MHz to 2.5 MHz, inclusive). For example, the frequency F0 is set to a numerical value of about 2.3 MHz. The voltage amplitude of the drive signal D0 is, for example, 5 Vp-p (peak to peak).

An output terminal of the drive circuit 41_n and one end of the drive coil 21_n are connected by a signal line 42. In addition, the other end of each of the drive coils 21_n is connected to a common line 47. The signal line 42 and the common line 47 are wirings formed on the wiring substrate 20. The common line 47 is grounded.

A capacitor 43, a low-pass filter 44, a resistive element 45, and a capacitor 46 are installed on the signal line 42. The capacitor 43 removes the DC component of the drive signal D. The low-pass filter 44 suppresses the high-frequency components of the drive signal D. The drive coil 21_n, the resistive element 45, and the capacitor 46 constitute a resonance circuit. The resistance value of the resistive element 45 and the capacitance value of the capacitor 46 are set such that the resonance frequency of the resonance circuit matches or approximates the frequency F0 of the drive signal D0, and that the Q value of the resonance characteristic becomes an appropriate numerical value.

In the configuration described above, the drive signal D obtained by removing the high-frequency components from the drive signal D0 output from the drive circuit 41_n is supplied to the drive coil 21_n. The drive signal D is a sinusoidal periodic signal whose voltage fluctuates at the frequency F0 equivalent to that of the drive signal D0. The voltage amplitude of the drive signal D is, for example, about 3.8 Vp-p.

The voltage detection unit 50 of FIG. 11 detects a detection voltage V_m for each of the five strings 15_1 to 15_5 at each supply period T_n. As described above, the detection voltage V_m fluctuates periodically in the same manner as the drive signal D. In a case where the voltage amplitude of the initial drive signal D0 is 5 Vp-p, the voltage amplitude of the detection voltage V_m will be about 10 mVp-p. The voltage detection unit 50 amplifies the detection voltage V_m to a detectable voltage.

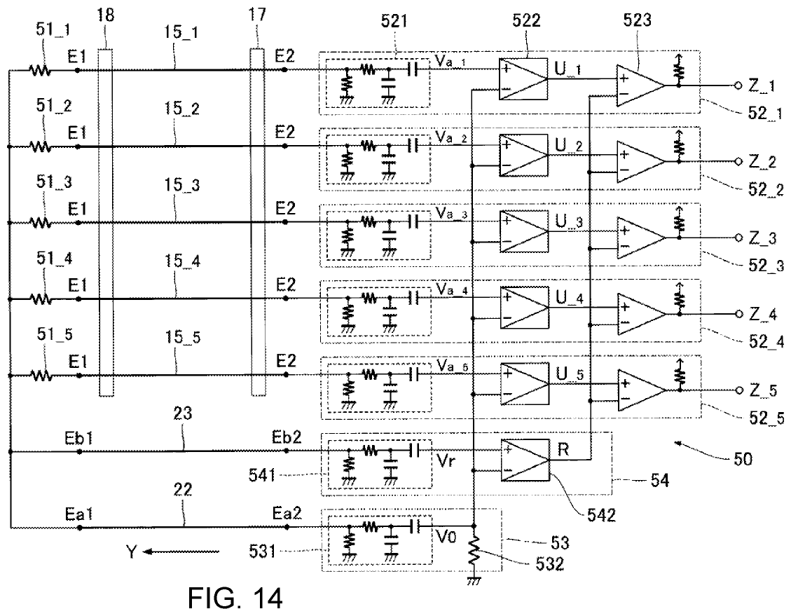

FIG. 14 is a circuit diagram showing a configuration of the voltage detection unit 50. FIG. 14 shows the first end E1 and the second end E2 of each of the strings 15_m. The first end E1 is the end of the string 15_m that is fixed to the head 13, and the second end E2 is the end of the string 15_m that is fixed to the body 10 (bridge 17).

FIG. 14 shows the first end Ea1 and the second end Ea2 of the feedback line 22, and a first end Eb1 and a second end Eb2 of the reference line 23. The first end Eb1 is the end of the reference line 23 located in the positive direction of the Y axis, and the second end Eb2 is the end of the reference line 23 located in the negative direction of the Y axis. As described above, the first end E1 of each of the five strings 15_1 to 15_5 is connected to the first end Ea1 of the feedback line 22. Similarly, the first end Eb1 of the reference line 23 is connected to the first end Ea1 of the feedback line 22.

A resistive element 51_m is connected between the feedback line 22 and the first end E1 of each of the strings 15_m. Specifically, one end of the resistive element 51_m is connected to the first end E1 of the string 15_m, and the other end of the resistive element 51_m is connected to the first end Ea1 of the feedback line 22. The resistive element 51_m is a resistor for ensuring the impedance of the detection coil 28_m in a state in which the first fret 14_1 is fretted. The resistance value of the resistive element 51_m is greater than the resistance value of the string 15_m. A resistive element 51_m1 is one example of the “first resistive element” and a resistive element 51_m2 is one example of the “second resistive element.”

The resistance component of the strings 15_m themselves differs for each of the strings 15_m due to individual differences. According to the first embodiment, since the resistive element 51_m is connected to each of the strings 15_m, the discrepancy in the impedance between the five strings 15_1 to 15_5 is reduced. That is, the impedance of the five strings 15_1 to 15_5 can be equalized. Note that the resistive element 51_m is not installed for the reference line 23.

The voltage detection unit 50 includes five detection units (detectors) 52_1 to 52_5, an output circuit 53, and a reference unit 54. The five detection units 52_1 to 52_5 each correspond to different strings 15_m. The second end E2 of each of the strings 15_m is connected to the detection unit 52_m. Each of the detection units 52_m is a circuit for detecting the detection voltage V_m of the string 15_m. The five detection units 52_1 to 52_5 detect, in parallel, detection voltages V_1 to V_5 of five systems, each corresponding to different strings 15_m. Note that one detection unit 52_m can detect, on a time-division basis, the detection voltage V_m relating to each of the five strings 15_1 to 15_5.

Each of the detection units 52_m includes a band-pass filter 521, an amplifier 522, and a comparator 523. The band-pass filter 521 includes two resistors and two capacitors, and selectively passes components of the voltage at the second end E2 of the string 15_m of a frequency band that includes the frequency F0 of the drive signal D. The voltage Va_m after processing by the band-pass filter 521 is supplied to a positive input terminal (+) of the amplifier 522.

The output circuit 53 includes a band-pass filter 531 and a resistive element 532. The band-pass filter 531 selectively passes components of the voltage at the second end Ea2 of the feedback line 22 of a frequency band that includes the frequency F0 of the drive signal D. The voltage V0 after processing by the band-pass filter 531 is supplied to a negative input terminal (−) of the amplifier 522 in each of the detection units 52_m. The negative input terminal of the amplifier 522 in each of the five detection units 52_1 to 52_5 is grounded via the resistive element 532. The difference between the voltage Va_m and the voltage V0 (differential input voltage) corresponds to the detection voltage V_m.

The amplifier 522 of each of the detection units 52_m is an amplifier that detects and amplifies the detection voltage V_m of the string 15_m. Specifically, the amplifier 522 amplifies the detection voltage V_m with a gain of about 45 dB, for example. The amplifier 522 generates detection voltage U_m by detecting the amplified detection voltage V_m. Specifically, the amplifier 522 outputs the detection voltage U_m having a voltage value corresponding to the voltage amplitude of the detection voltage V_m.

As described above, since the voltage amplitude of the detection voltage V_m changes in accordance with the fretting position of the string 15_m, the voltage value of the detection voltage U_m also changes in accordance with the fretting position of the string 15_m. Accordingly, it is possible to use the detection voltage U_m to identify the fretting position of the string 15_m. For example, it is possible to identify the fretting position by determining, at each supply period T_n, whether the detection voltage U_m exceeds a prescribed threshold value.

Focusing on any two detection units 52_m1 and 52_m2, the amplifier 522 of the detection unit 52_m1 is one example of the “first detection circuit” and the amplifier 522 of the detection unit 52_m2 is one example of the “second detection circuit”. In addition, a detection voltage V_m1 and a detection voltage U_m1 are examples of the “first detection voltage” and a detection voltage V_m2 and a detection voltage U_m2 are examples of the “second detection voltage.”

Incidentally, as a form of performance by a performer, in addition to a performance in which only one string 15_m of the five strings 15_1 to 15_5 is fretted, it is also possible to conceive of a performance in which a plurality of the strings 15_m are fretted in parallel. In a state in which a plurality of the strings 15_m are fretted in parallel, the plurality of strings 15_m are electrically connected via the fret 14_n. Accordingly, in a state in which the plurality of strings 15_m are fretted in parallel, the detection voltage U_m corresponding to each of the strings 15_m decreases, compared to a state in which only one of the strings 15_m is fretted.

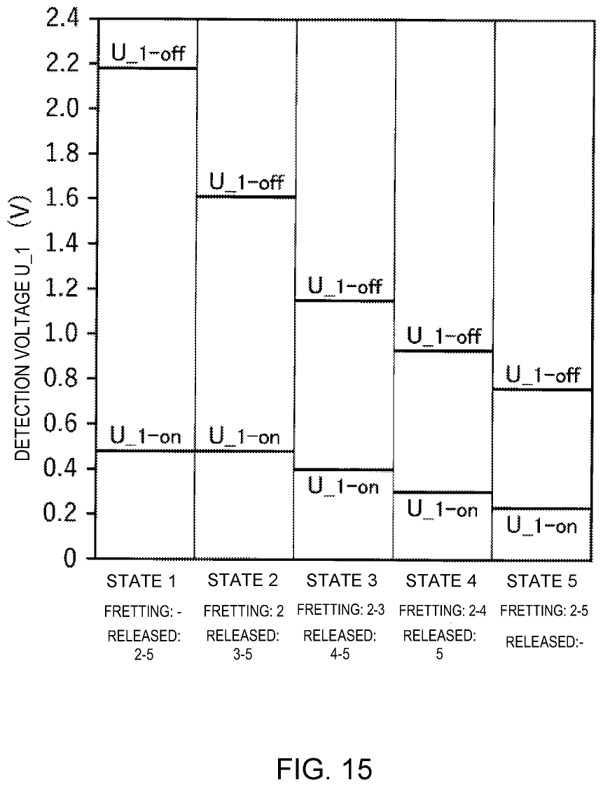

FIG. 15 is an explanatory diagram relating to drops in the detection voltage U_1 due to fretting of a plurality of the strings 15_m. In FIG. 15, the detection voltage U_1 of the string 15_1 is shown on the vertical axis. Voltage U_1-off in FIG. 15 is the detection voltage U_1 in a state in which the string 15_1 is not fretted (released state), and voltage U_1-on is the detection voltage U_1 in a state in which the string 15_1 is fretted. Fretting in FIG. 15 is a state in which two frets, the 15th fret 14_15 and the 16th fret 14_16, are in contact with the string 15_m due to the performer's fretting. Since the intervals between each of the frets 14_n are narrow in the area of the fingerboard 12 close to the second end E2 of each of the strings 15_m, two of the frets 14_n come in contact the string 15_m simultaneously even in a case where the performer frets only one location of the string 15_m. Given the circumstances described above, in FIG. 15, a state is assumed in which two of the frets 14_n (14_15, 14_16) are in contact with the string 15_m.

FIG. 15 illustrates a detection voltage U_1-off and a detection voltage U_1-on for each of a plurality of states in which the number of the strings 15_m fretted in parallel by the performer (hereinafter referred to as “number of simultaneously fretted strings”) is different. State 1 is a state in which four of the strings 15_2 to 15_5, excluding the string 15_1, are released. State 2 is a state in which the string 15_2 is fretted, and the strings 15_3 to 15_5 are released. State 3 is a state in which the strings 15_2 and 15_3 are fretted, and the strings 15_4 and 15_5 are released. State 4 is a state in which the strings 15_2 to 15_4 are fretted, and the string 15_5 is released. State 5 is a state in which four of the strings 15_2 to 15_5, excluding the string 15_1, are fretted. As can be understood from FIG. 15, the detection voltage U_1-off and the detection voltage U_1-on tend to decrease as the number of simultaneously fretted strings increases.

As described above, in order to accurately identify the fretting position of each of the strings 15_m even in a state in which the detection voltage U_m is dependent on the number of simultaneously fretted strings, the voltage of the reference line 23 (hereinafter referred to as “reference voltage R”) is used in the first embodiment.

As described above, since the reference line 23 is connected to the feedback line 22, the reference line 23 and the feedback line 22 constitute a single-turn coil (hereinafter referred to as “reference coil”), in the same manner as with the strings 15_m. Magnetic flux that is generated in each of the drive coils 21_n by the supply of the drive signal D is interlinked with the reference coil that includes the reference line 23 and the feedback line 22. Accordingly, in response to the drive signal D being supplied and a current flowing through the drive coil 21_n (primary coil), an electromotive force is generated in the reference coil (secondary coil) in addition to each of the detection coils 28_m by mutual induction caused by a magnetic field that is generated in the drive coil 21_n. The reference voltage R is the voltage between the feedback line 22 and the reference line 23.

The reference unit 54 in FIG. 14 is a circuit for detecting the reference voltage R. The reference unit 54 includes a band-pass filter 541 and an amplifier 542. The band-pass filter 541 selectively passes components of the voltage at the second end Eb2 of the reference line 23 of a frequency band that includes the frequency F0 of the drive signal D, in the same manner as the band-pass filter 521. A voltage Vr after processing by the band-pass filter 541 is supplied to a positive input terminal (+) of the amplifier 542. A voltage V0 after processing by the band-pass filter 541 is supplied to the negative input terminal (−) of the amplifier 542.

The amplifier 542 is an amplifier that detects and amplifies the voltage Vr of the reference line 23. The configuration of the amplifier 542 is the same as that of the amplifier 522. Accordingly, the amplifier 542 amplifies the differential voltage between the voltage Vr of the reference line 23 and the voltage V0 of the feedback line 22, and detects the amplified voltage to output the reference voltage R. That is, the reference voltage R is output, the voltage having a value corresponding to the voltage amplitude of the differential voltage between the voltage Vr and the voltage V0. The amplifier 542 amplifies the differential voltage with a gain of about 40 dB. That is, the gain of the amplifier 542 is lower than the gain of the amplifier 522.

The comparator 523 of each of the detection units 52 is a comparator that compares the detection voltage U_m and the reference voltage R and generates an output signal Z_m corresponding to the comparison result. The output signal Z_m is a binary signal that is set to either high level or low level for each supply period T_n, in synchronization with the supply of the drive signal D to each of the drive coils 21_n. Specifically, the comparator 523 sets the output signal Z_m to high level in a case where the detection voltage U_m is higher than the reference voltage R, and sets the output signal Z_m to low level in a case where the detection voltage U_m is lower than the reference voltage R. That is, the output signal Z_m is set to high level in a case where the difference voltage (U_m−R) between the detection voltage U_m and the reference voltage R is a positive number, and the output signal Z_m is set to low level in a case where the difference voltage (U_m−R) is a negative number. As described above, the reference voltage R corresponds to a threshold value that is compared to the detection voltage U_m .

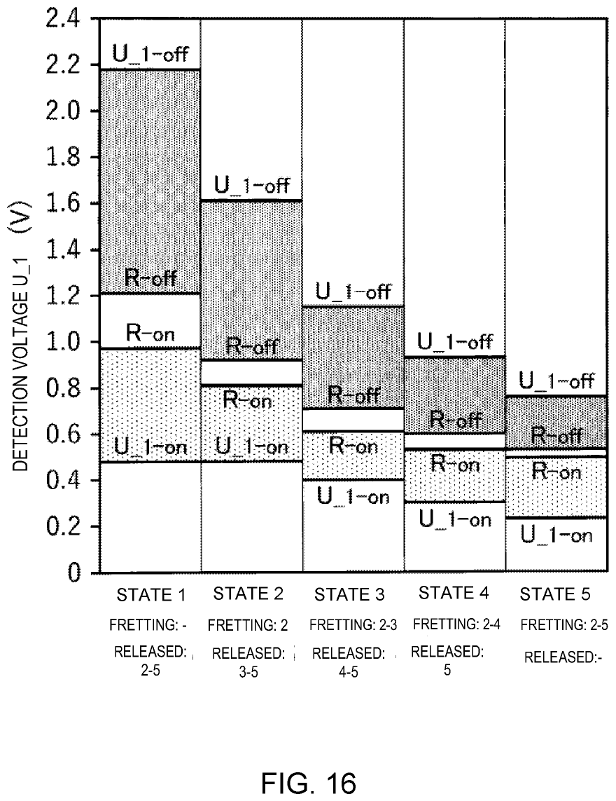

FIG. 16 is an explanatory diagram of the reference voltage R. FIG. 16 is a graph in which the reference voltage R (R-off, R-on) is shown alongside the detection voltage U_m illustrated in FIG. 15. The reference voltage R-off in FIG. 16 is the reference voltage R in a state in which the string 15_1 is released, and the reference voltage R-on is the reference voltage R in a state in which the string 15_1 is fretted.

As can be understood from FIG. 16, the reference voltage R of the reference line 23 fluctuates in accordance with the presence/absence of fretting of the string 15_1. Specifically, the reference voltage R-off in a state in which the string 15_1 is released is higher than the reference voltage R-on in a state in which the string 15_1 is fretted. In addition, as can be understood from FIG. 16, the reference voltage R-off and the reference voltage R-on tend to decrease as the number of simultaneously fretted strings increases. That is, the detection voltage U_1 and the reference voltage R are interlocked in accordance with the number of simultaneously fretted strings. Accordingly, by analyzing the detection voltage U_m using the reference voltage R as the reference value, the presence/absence of fretting on the string 15_m (as well as the fretting position) can be determined with high accuracy.

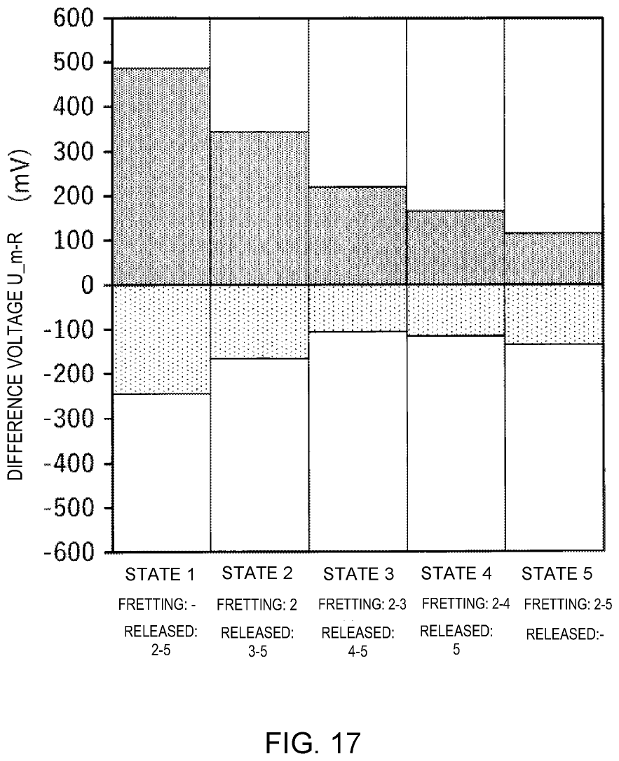

FIG. 17 is a graph in which each of the states 1 to 5 is shown alongside the difference voltage (U_1−R) between the detection voltage U_1 and the reference voltage R. As described above, it can be confirmed from FIG. 17 that the presence/absence of fretting of the string 15_1 can be accurately determined by a configuration that determines the polarity of the difference voltage (U_1−R) between the detection voltage U_m and the reference voltage R. That is, the comparator 523 sets the output signal Z_m to high level in a case where the difference voltage (U_m−R) between the detection voltage U_m and the reference voltage R is a positive number, and sets the output signal Z_m to low level in a case where the difference voltage (U_m−R) is a negative number.

As described above, the reference voltage R fluctuates together with each of the detection voltages U_m in accordance with the number of simultaneously fretted strings. Therefore, according to the above-mentioned configuration in which each of the detection voltages U_m and the reference voltage R are compared, the fretting position of each of the strings 15_m can be accurately identified even in a case where a plurality of the strings 15_m are fretted simultaneously.

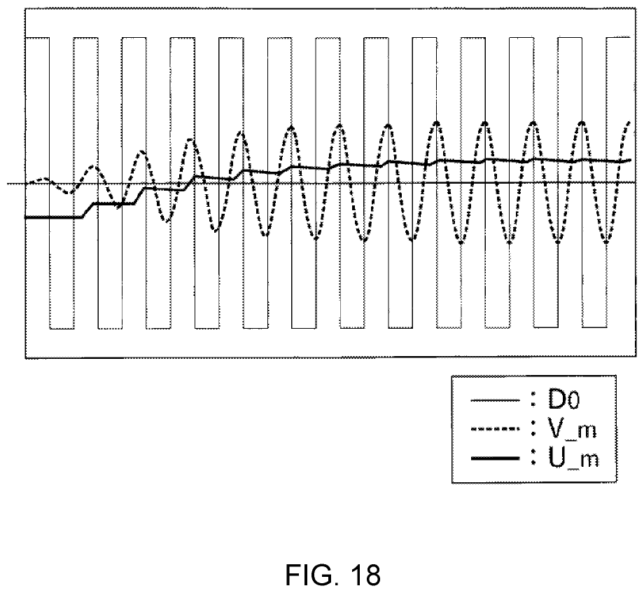

FIG. 18 is an explanatory diagram of the transient response relating to the amplifier 522. In FIG. 18, the waveform of the drive signal D0 and time fluctuation of the detection voltage V_m and the detection voltage U_m are shown side by side. It can be ascertained from FIG. 18 that the detection voltage U_m reaches a steady-state voltage after a length of time corresponding to approximately 10 waves of the drive signal D0. In a case where the frequency F0 of the drive signal D0 is assumed to be 2.3 MHz, the length of time required for the rise of the detection voltage U_m is about 4 microseconds. On the other hand, from the point in time at which the supply of the drive signal D to the drive coil 21_n ends, the detection voltage U_m falls over a length of time corresponding to approximately 26 waves of the drive signal D0 (approximately 11 microseconds).

As described above, the length of time required for the fall of the detection voltage U_m is longer than the length of time required for the rise of the detection voltage U_m . That is, the rising of the detection voltage U_m is faster than the falling of the detection voltage U_m . Accordingly, a length of time required for the falling of the detection voltage U_m is secured as the length of time of each supply period T_n. In a case where the number N of the frets 14_n is assumed to be 24, the time required for supplying the drive signal D to all of the frets 14_n is about 0.27 microseconds (=24×26×1/2.3 MHz). Accordingly, it is possible to identify the fretting position of each of the strings 15_m with a sufficiently low latency that would be imperceptible to the performer.

The fretting analysis unit 60A identifies, in accordance with the output signal Z_m corresponding to each of the strings 15_m, the fretting position of the string 15_m. For example, in a case where the output signal Z_m changes from low level to high level during the supply period T_n, the fretting analysis unit 60A identifies the fret 14_n−1 as the fretting position of the string 15_m.

### B: Third Embodiment

The third embodiment will be described. Note that, in each of the embodiments illustrated below, elements that have the same functions as those in the first embodiment have been assigned the same reference symbols used to describe the first embodiment and detailed descriptions of the first embodiment have been appropriately omitted.

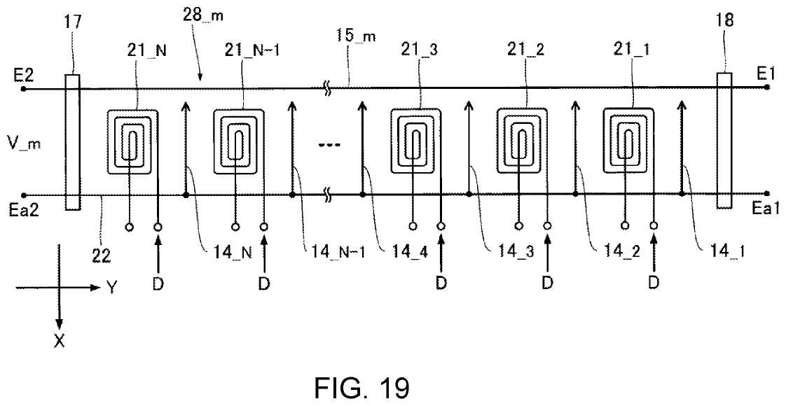

FIG. 19 is an explanatory diagram of the principle for detecting the fretting position of any one of the strings 15_m according to a third embodiment. The electric bass 100 according to the third embodiment includes N drive coils 21_1 to 21_N, each corresponding to a different fret 14_n, in the same manner as in the first embodiment. A drive signal D is sequentially supplied on a time-division basis to each of the N drive coils 21_1 to 21_N.

In the first embodiment, the drive coils 21_n are positioned between two adjacent frets 14_n and 14_n−1 (FIG. 2). That is, the drive coil 21_n is located in the positive direction of the Y axis relative to the fret 14_n. As illustrated in FIG. 19, the drive coil 21_n in the third embodiment is located between two adjacent frets 14_n and 14_n+1 That is, the drive coil 21_n is located in the negative direction of the Y axis relative to the fret 14_n.

The feedback line 22 is wiring extending in the Y-axis direction spaced apart from each of the strings 15_m and includes a first end Ea1 and a second end Ea2, in the same manner as in the first embodiment. In the first embodiment, the first end E1 of each of the strings 15_m is connected to the feedback line 22. In the third embodiment, each of the strings 15_m is not electrically connected to the feedback line 22. Each of the N frets 14_1 to 14_N is electrically connected to the feedback line 22, in the same manner as in the first embodiment. In the third embodiment, the above-mentioned reference line 23 can be omitted.

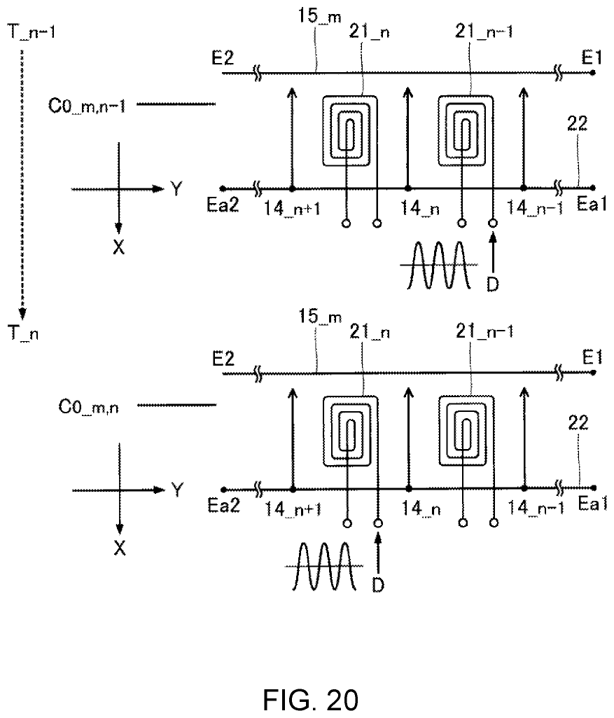

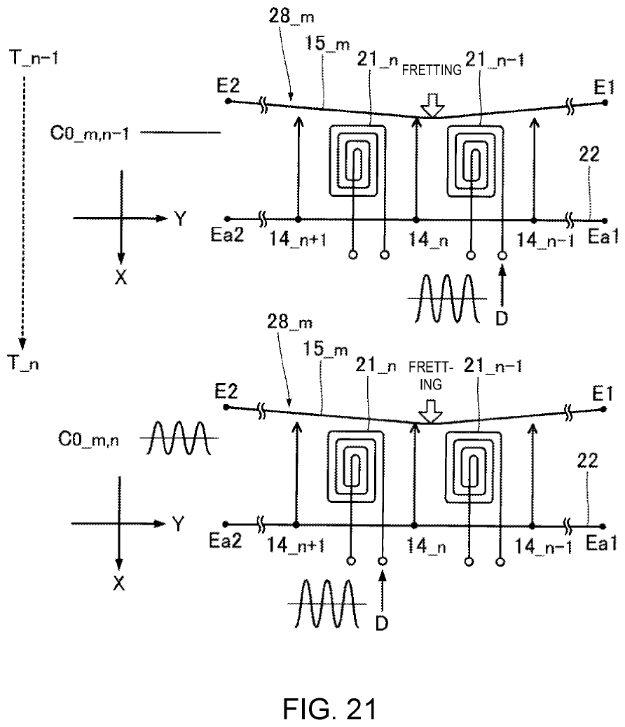

FIGS. 20 and 21 show the drive coils 21_n−1 and 21_n, and the frets 14_n−1 and 14_n. The voltage C0_m, n of FIGS. 20 and 21 is the voltage of the string 15_m during the period in which the drive signal D is supplied to any one drive coil 21_n.

In FIG. 20, a state in which the string 15_m is not being fretted is assumed. In the state shown in FIG. 20, since the feedback line 22 and the string 15_m are in a state of being electrically insulated, the detection coil 28_m is not formed. Accordingly, even in a case where the drive signal D is supplied and current flows through the drive coil 21_n−1 during the supply period T_n−1, the voltage C0_m, n−1 of the string 15_m essentially does not fluctuate. Similarly, in a case where the drive signal D is supplied and current flows through the drive coil 21_n during the immediately succeeding supply period T_n, the voltage C0_m, n of the string 15_m essentially does not fluctuate.

In FIG. 21, a state in which the string 15_m contacts the fret 14_n due to the performer's fretting is assumed. That is, the fret 14_n is the fretting position. As a result of the string 15_m coming in contact with the fret 14_n, a single-turn detection coil 28_m is formed by the string 15_m, the fret 14_n, and the feedback line 22.

In the state shown in FIG. 21, in response to the drive signal D being supplied and current flows through the drive coil 21_n−1 during the supply period T_n−1, the voltage C0_m, n−1 of the string 15_m essentially does not fluctuate. On the other hand, in response to the drive signal D being supplied and a current flowing through the drive coil 21_n (primary coil) during the immediately succeeding supply period T_n, an electromotive force is generated in the detection coil 28_m (secondary coil) including the string 15_m, the fret 14_n, and the feedback line 22, by mutual induction caused by a magnetic field that is generated in the drive coil 21_n. Accordingly, the detection voltage C0_m, n fluctuates periodically in the same manner as the drive signal D.

As illustrated above, in a state in which the string 15_m and the fret 14_n are not in contact (FIG. 20), the voltage C0_m, n and the voltage C0_m, n−1 of the string 15_m are essentially the same, whereas in a state in which the string 15_m and the fret 14_n are in contact due to fretting (FIG. 21), the voltage C0_m, n−1 and the voltage C0_m, n are different. That is, the voltages C0_m, 1 to C0_m, n−1 are different from the voltages C0_m, n to C0_m, N. Accordingly, it is possible to identify the fretting position of each of the strings 15_m in accordance with the presence/absence of changes in the N voltages C0_m, 1 to C0_m, N detected during different supply periods T_n. Specifically, as illustrated above, in a case where the voltages C0_m, 1 to C0_m, n−1 are different from the voltages C0_m, n to C0_m, N, it can be determined that the position of the fret 14_n of the string 15_m has been fretted.

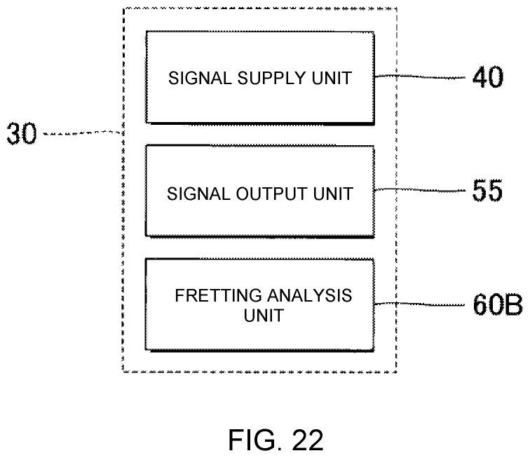

FIG. 22 is a block diagram illustrating a configuration of the detection device 30 according to the third embodiment. The detection device 30 of the third embodiment includes the signal supply unit 40, a signal output unit 55, and a fretting analysis unit 60B. The signal supply unit 40 supplies the drive signal D to each of the N drive coils 21_1 to 21_N, in the same manner as in the first embodiment. Specifically, the drive signal D is supplied on a time-division basis to each of the N drive coils 21_1 to 21_N at each supply period T_n.

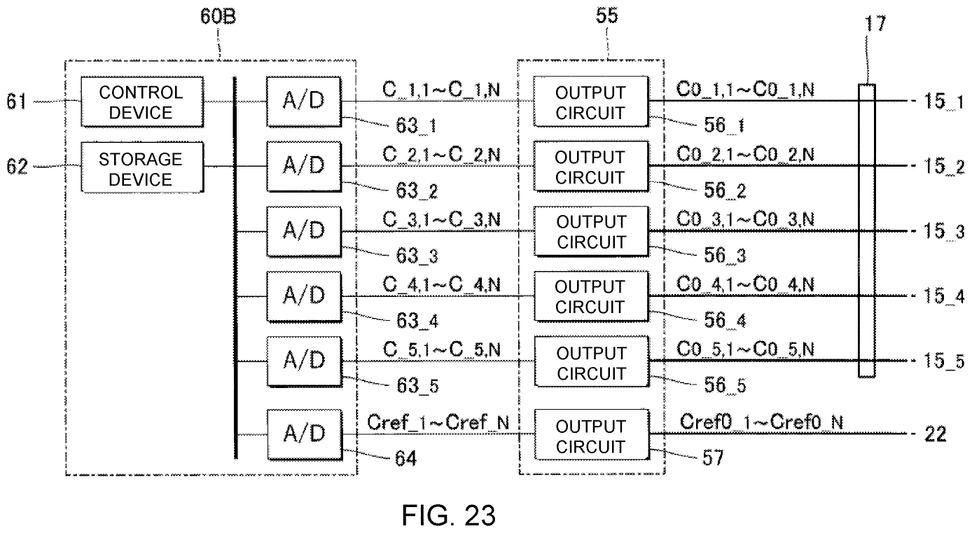

FIG. 23 is a block diagram illustrating configurations of the signal output unit 55 and the fretting analysis unit 60B. The signal output unit 55 generates a voltage C_m, n corresponding to the voltage C0_m, n of each of the strings 15_m, and a voltage (hereinafter referred to as “reference voltage”) Cref_n corresponding to a voltage Cref0_n of the feedback line 22. As described above with reference to FIGS. 20 and 21, the voltage C0_m, n is the voltage of the string 15_m during the supply period T_n in which the drive signal D is supplied to the drive coil 21_n. On the other hand, the voltage Cref0_n is the voltage of the feedback line 22 during the supply period T_n.

The signal output unit 55 includes five output circuits 56_1 to 56_5 corresponding to different strings 15_m, and an output circuit 57 corresponding to the feedback line 22. The output circuit 56_m generates the voltage C_m, n corresponding to the voltage C0_m, n of the string 15_m during the supply period T_n. Specifically, the output circuit 56_m includes an amplifier that amplifies the voltage C0_m, n, a rectifier circuit that rectifies the amplified voltage C0_m, n, and a smoothing circuit that smooths the rectified voltage C_m, n. Accordingly, the voltage C_m, n is a DC (direct current) voltage corresponding to the amplitude of the voltage C0_m, n. Similarly, the output circuit 57 generates the reference voltage Cref_n corresponding to the voltage Cref0_n of the feedback line 22 during the supply period T_n. Specifically, the output circuit 57 includes an amplifier that amplifies the voltage Cref0_n, a rectifier circuit that rectifies the amplified voltage Cref0_n, and a smoothing circuit that smooths the rectified voltage Cref0_n. Accordingly, the reference voltage Cref_n is a DC voltage corresponding to the amplitude of the voltage Cref0_n.

The fretting analysis unit 60B identifies the presence/absence as well as the position (fretting position) of fretting of each of the strings 15_m in accordance with the voltage C_m, n of each of the strings 15_m and the reference voltage Cref_n of the feedback line 22. Specifically, the fretting analysis unit 60B includes a control device 61 and a storage device 62, five A/D converters 63_1 to 63_5 corresponding to different strings 15_m, and an A/D converter 64 corresponding to the feedback line 22.

The A/D converter 63_m converts the voltage C_m, n supplied from the output circuit 56_m from analog to digital. The A/D converter 64 converts the reference voltage Cref_n supplied from the output circuit 57 from analog to digital.

The control device 61 is an electronic controller that includes one or more processors that execute various computational and control processes. Specifically, the control device 61 includes one or more types of processors, such as a CPU (Central Processing Unit), a GPU (Graphics Processing Unit), a DSP (Digital Signal Processor), an FPGA (Field Programmable Gate Array), an ASIC (Application Specific Integrated Circuit), and the like. Here, the term “electronic controller” as used herein refers to hardware, and does not include a human.

The storage device 62 includes one or more memory units (computer memories) for storing a program that is executed by the control device 61 and various data that are used by the control device 61. A known storage medium, such as a magnetic storage medium or a semiconductor storage medium, or a combination of a plurality of types of storage media can be used as the storage device 62.

The storage device 62 stores detection data for each unit period. A unit period is a period that serves as the cycle in which the drive signal D is supplied to each of the N drive coils 21_1 to 21_N. That is, the unit period is a period corresponding to N times the period during which the drive signal D is supplied to each of the drive coils 21_n.

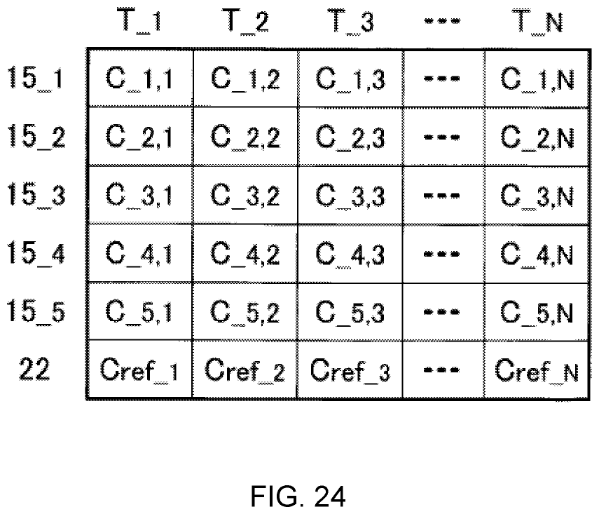

FIG. 24 is a schematic diagram of detection data. The detection data include, for each of the five strings 15_1 to 15_5, N voltages C_m, 1 to C_m, N corresponding to different supply periods T_n. Each voltage C_m, n is a numerical value after conversion by the A/D converter 63_m. The voltage C_m, n can also be expressed as a numerical value corresponding to the drive coil 21_n or a numerical value corresponding to the fret 14_n. In addition, the detection data include N reference voltages Cref_1 to Cref_N corresponding to different supply periods T_n. Each of the reference voltages Cref_n is a numerical value after conversion by the A/D converter 64.

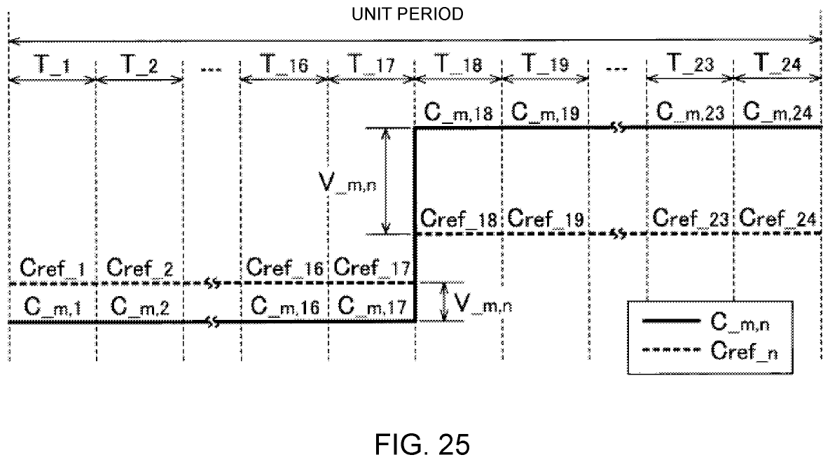

FIG. 25 is a schematic diagram of temporal changes in the N voltages C_m, 1 to C_m, N stored in the detection data for any one of the strings 15_m, and the N reference voltages Cref_1 to Cref_N stored in the detection data with respect to the feedback line 22. In FIG. 25, a state is assumed in which the total number N of the frets 14_n is “24” and one of the frets 14_18 is being fretted. Of the N frets 14_1 to 14_N, the last fret 14_N (N=24) closest to the bridge 17 is referred to as the “final fret” in the following description.

As illustrated in FIG. 25, the voltages C_m, 1 to C_m, 17 from the first supply period T_1 to the supply period T_17 immediately preceding the supply period T_18 corresponding to the fretting position within a unit period, are lower than the voltages C_m, 18 to C_m, 24 from the supply period T_18 corresponding to the fretting position to the supply period T_24 corresponding to the final fret 14_24. Similarly, the reference voltages Cref_1 to Cref_17 from the first supply period T_1 to the supply period T_17 within a unit period≤are lower than the reference voltages Cref_18 to Cref_24 from the supply period T_18 to the supply period T_24 corresponding to the fretting position.

FIG. 25 show the difference (hereinafter referred to as “detection voltage”) V_m, n between the voltage C_m, n and the reference voltage Cref_n during each of the supply periods T_n(V_m, n=|C_m, n-Cref_n|). As can be understood from FIG. 25, the detection voltages V_m, 1 to V_m, 17 from the first supply period T_1 to the supply period T_17 immediately preceding the supply period T_18 corresponding to the fretting position within a unit period, are lower than the detection voltages V_m, 18 to V_m, 24 from the supply period T_18 corresponding to the fretting position to the supply period T_24 corresponding to the final fret 14_24. As can be understood from the foregoing explanation, it is possible to identify the presence/absence as well as the position (fretting position) of fretting of each of the strings 15_m in accordance with the presence/absence as well as the point in time of a change in the detection voltage V_m within a unit period.

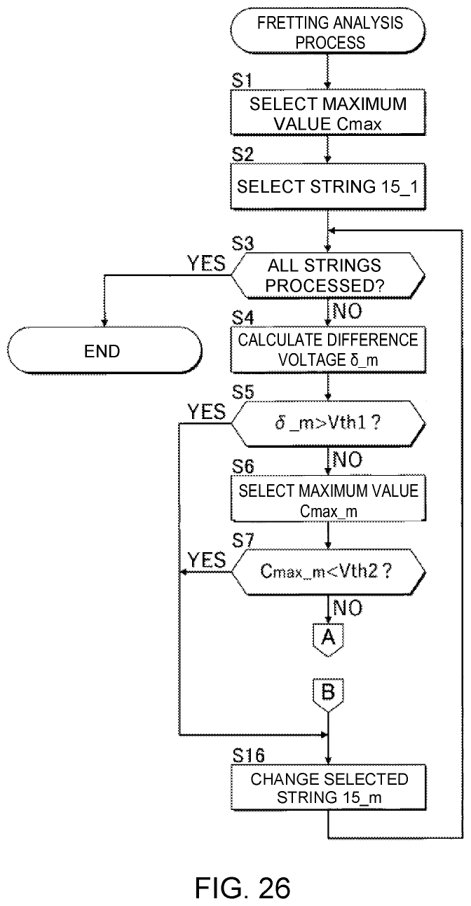

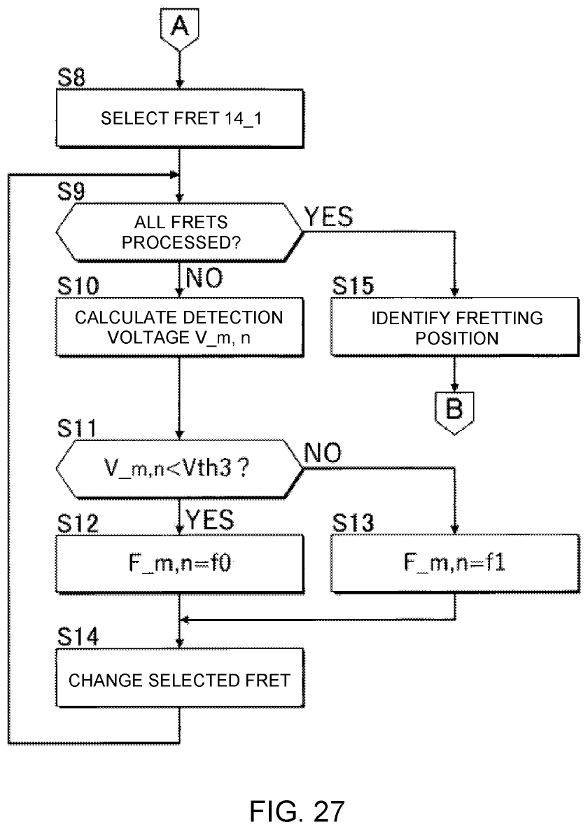

FIGS. 26 and 27 are flowcharts of a process (hereinafter referred to as “fretting analysis process”) that is executed by the control device 61 (fretting analysis unit 60B) to identify the fretting position of each of the strings 15_m. The fretting analysis process is executed each time the detection data are updated within each unit period. That is, the fretting analysis process is executed for each unit period.

In response to the fretting analysis process starting, the control device 61 selects the maximum value Cmax from the five voltages C_1, N to C_5, N corresponding to different strings 15_m (S1). The candidate voltages C_m, N from which the maximum value Cmax is selected are voltages corresponding to the final fret 14N, from among the N voltages C_m, 1 to C_m, N corresponding to the strings 15_m. That is, the maximum value Cmax is selected from the five voltages C_1, N to C_5, N during the supply period T_N during which the drive signal D is supplied to the last drive coil 21_N.

The control device 61 selects one of the five strings 15_1 to 15_5 (hereinafter referred to as “selected string 15_m”) (S2). For example, the control device 61 initializes the number m of the selected string 15_m to “1.” The control device 61 determines whether the process has been executed for all of the five strings 15_1 to 15_5 (S3). Upon determining that the process has been executed for all of the strings 15_m (S3: YES), the control device 61 ends the fretting analysis process.

In a cases where there is an unselected string 15_m (S3: NO), the control device 61 calculates a difference voltage δ_m for the selected string 15_m (S4). The difference voltage δ_m is a numerical value obtained by subtracting the voltage C_m, N corresponding to the selected string 15_m and the final fret 14_N from the maximum value Cmax (δ_m=Cmax−C_m, N).

There are cases in which the voltage C_m, n of the selected string 15_m is affected by another string 15_m′. The voltage C_m, n of the selected string 15_m can be increased due to influence of other strings 15_m′, n even in a case where the string is actually not being fretted. That is, in a state in which the voltage C_m, n of the selected string 15_m is affected by another string 15_m′ (hereinafter referred to as “crosstalk state”), the difference voltage δ_m increases compared to a state in which the voltage C_m, n is not affected by another string 15_m′. Considering the tendency described above, the control device 61 determines whether the selected string 15_m is in a crosstalk state in accordance with whether the difference voltage δ_m is higher than a prescribed threshold value Vth1.

Specifically, in a case where the difference voltage δ_m is higher than the threshold value Vth1 (S5: YES), the control device 61 determines that the selected string 15_m is in a crosstalk state and advances the process to step S16. On the other hand, in a case where the difference voltage δ_m is lower than the threshold value Vth1 (S5: NO), the control device 61 determines that the selected string 15_m is not in a crosstalk state and advances the process to step S6. In a case where the difference voltage δ_m is equal to the threshold value Vth1, the result of the determination by the control device 61 can be either affirmative or negative.

The control device 61 selects the maximum value Cmax_m from the N voltages C_m, 1 to C_m, N corresponding to the selected string 15_m (S6). As described above, since the voltage C_m, n increases with fretting, in a case where the selected string 15_m is in the released state (state of not being fretted), the maximum value Cmax_m is maintained at a low voltage. Considering the tendency described above, the control device 61 determines whether the selected string 15_m is in a released state in accordance with whether the maximum value Cmax_m of the selected string 15_m is lower than a prescribed threshold value Vth2 (S7).

Specifically, in a case where the maximum value Cmax_m is lower than the threshold value Vth2 (S7: YES), the control device 61 determines that the selected string 15_m is in a released state and advances the process to step S16. On the other hand, in a case where the maximum value Cmax_m is higher than the threshold value Vth2 (S7: NO), the control device 61 determines that the selected string 15_m is not in a released state and advances the process to step S8. In a case where the maximum value Cmax_m is equal to the threshold value Vth2, the result of the determination by the control device 61 can be either affirmative or negative.

The control device 61 selects one of the N frets 14_1 to 14_N (hereinafter referred to as “selected fret 14_n”) (S8). For example, the control device 61 initializes the number n of the selected fret 14_n to “1.” Each of the N frets 14_1 to 14_N is sequentially selected in order as the selected fret 14_n in the negative direction of the Y axis. The control device 61 determines whether the process has been executed for all of the N frets 14_1 to 14_N (S9).

In a case where there is an unselected fret 14_n (S9: NO), the control device 61 calculates a detection voltage V_m, n corresponding to the selected string 15_m and the selected fret 14_n (S10). As described above, the detection voltage V_m, n is the difference between the voltage C_m, n and the reference voltage Cref_n in each of the supply periods T_n (V_m, n=|C_m, n-Cref_n|). As described above, the control device 61 (fretting analysis unit 60B) of the third embodiment functions as an element (voltage detection unit) that detects the detection voltage V_m between each of the strings 15_m and the feedback line 22.

As described above with reference to FIG. 25, the detection voltage V_m, n tends to increase in a case where a position corresponding to the selected fret 14_n is fretted. Considering the tendency described above, the control device 61 determines whether the detection voltage V_m, n is lower than a prescribed threshold value Vth3 (S11).

In a case where the detection voltage V_m, n is lower than the threshold value Vth3 (S11: YES), the control device 61 sets a fretting flag F_m, n to a numerical value f0 (for example, zero) (S12). On the other hand, in a case where the detection voltage V_m, n is higher than the threshold value Vth3 (S11: NO), the control device 61 sets the fretting flag F_m, n to a numerical value f1 different from the numerical value f0 (for example, one) (S13). The fretting flag F_m, n is information for searching the fretting position of the selected string 15_m. The numerical value f0 of the fretting flag F_m, n indicates that the selected fret 14_n and the feedback line 22 are not short-circuited. On the other hand, the numerical value f1 of the fretting flag F_m, n indicates that the selected fret 14_n and the feedback line 22 are in contact due to fretting.

The control device 61 adds “1” to the number n of the selected fret 14_n (S14). That is, the selected fret 14_n is changed. In response to the setting of the fretting flag F_m, n being executed for all of the N frets 14_1 to 14_N, the determination result in step S9 transitions from negative to affirmative. The control device 61 uses N fretting flags F_m, 1 to F_m, N corresponding to different frets 14_n to identify the fretting position of the selected string 15_m (S15). Specifically, the control device 61 identifies, as the fretting position of the selected string 15_m, a position corresponding to the boundary between the numerical value f0 and the numerical value f1 in the sequence of the N fretting flags F_m, 1 to F_m, N. As described above, the fretting analysis unit 60B of the third embodiment identifies, as the fretting position, the fret 14_n that is in contact with the string 15_m from among the N frets 14_1 to 14_N, in accordance with changes in the detection voltage V_m, n detected each time the drive signal D is supplied.

In step S16 of FIG. 26, the control device 61 adds “1” to the number m of the selected string 15_m. That is, the selected string 15_m is changed. In response to the process described above being executed for all of the five strings 15_1 to 15_5, the determination result in step S3 transitions from negative to affirmative. As explained above, presence/absence as well as the position of fretting (fretting position) are identified for each of the five strings 15_1 to 15_5.

The same effects as those of the first embodiment are realized in the third embodiment. In addition, in the third embodiment, the control device 61 executes a program, thereby realizing the detection of the fretting position corresponding to each of the detection voltages V_m, n. Accordingly, there is the advantage that the configuration and operation of the detection device 30 are simplified compared to the first embodiment.

### C: Fourth Embodiment

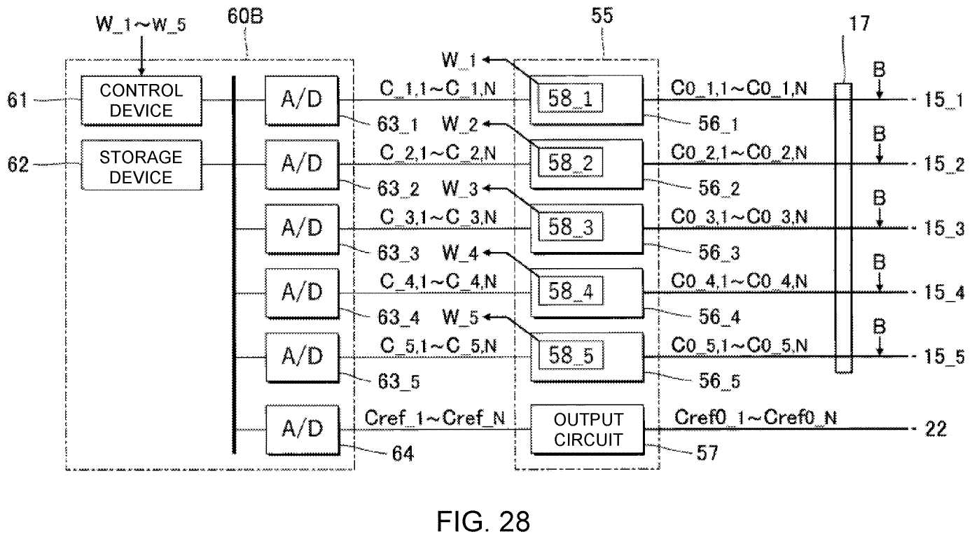

FIG. 28 is a block diagram illustrating configurations of the signal output unit 55 and the fretting analysis unit 60B according to a fourth embodiment. In the fourth embodiment, DC voltage B is applied to each of the five strings 15_1 to 15_5. The DC voltage B is a bias voltage that is maintained at a prescribed voltage value (for example, 5V). For example, the signal supply unit 40 applies the DC voltage B to each of the strings 15_m.

The signal output unit 55 of the fourth embodiment includes five output circuits 56_1 to 56_5 corresponding to different strings 15_m, and an output circuit 57 corresponding to the feedback line 22, in the same manner as in the first embodiment. Each of the output circuits 56_m generates the voltage C_m, n corresponding to the voltage C0_m, n of the string 15_m during the supply period T_n, in the same manner as in the first embodiment. Specifically, the output circuit 56_m includes a DC removal circuit that removes DC components (DC voltage B) from the voltage C0_m, n, and an electrical circuit (such as an amplifier, a rectifier circuit, or a smoothing circuit) that generates voltage C_m, n from the voltage after the removal.

In addition, the output circuit 56_m of the fourth embodiment includes a comparator 58_m, in addition to the above-mentioned circuit that generates the voltage C_m, n corresponding to the voltage C0_m, n. The comparator 58_m compares the voltage C0_m, n of the string 15_m that includes the DC voltage B with a prescribed threshold value. The threshold value is a prescribed voltage that is lower than the DC voltage B.

The comparator 58_m generates a binary signal W_m corresponding to the result of comparing the voltage C0_m, n with the threshold value. In a case where the voltage C0_m, n is higher than the threshold value, the comparator 58_m outputs a high-level signal W_m. On the other hand, in a state where the voltage C0_m, n is lower than the threshold value, the comparator 58_m outputs a low-level signal W_m.

In a case where the string 15_m is in the released state, the voltage C0_m, n is a high voltage that approximates the DC voltage B, and thus the signal W_m is set to high level. On the other hand, in a state in which the string 15_m is connected to the feedback line 22 due to fretting, the voltage C0_m, n decreases to a voltage that is lower than the DC voltage B. Accordingly, the signal W_m is set to low level. As described above, the signal W_m is a binary signal indicating whether the string 15_m is in the released state.

Each signal W_m is supplied to the fretting analysis unit 60B (control device 61). The control device 61 determines, for each of the five strings 15_1 to 15_5, whether each string 15_m is in the released state in accordance with the level of the signal W_m. Specifically, the control device 61 determines that the string 15_m is in the released state in a case where the signal W_m is high level, and determines that the string 15_m is not in the released state in a case where the signal W_m is low level. As described above, the detection device 30 (signal output unit 55 and fretting analysis unit 60B) of the fourth embodiment functions as an element (fretting determination unit) that determines, in accordance with the voltage C0_m, n of each of the strings 15_m, the presence/absence (presence or absence) of fretting on each string 15_m.

As described above, since, in the fourth embodiment, the presence/absence of fretting on the string 15_m is determined in accordance with the signal W_m, the process (S6, S7) of determining whether the selected string 15_m is in a released state can be omitted from the fretting analysis process.

The same effects as those of the first embodiment and the third embodiment are also achieved in the fourth embodiment. In addition, in the fourth embodiment, there is the advantage that it is possible to accurately determine, in accordance with the voltage of each of the strings 15_m to which the DC voltage B is applied, the presence/absence of fretting on each string 15_m.

### D: Fifth Embodiment

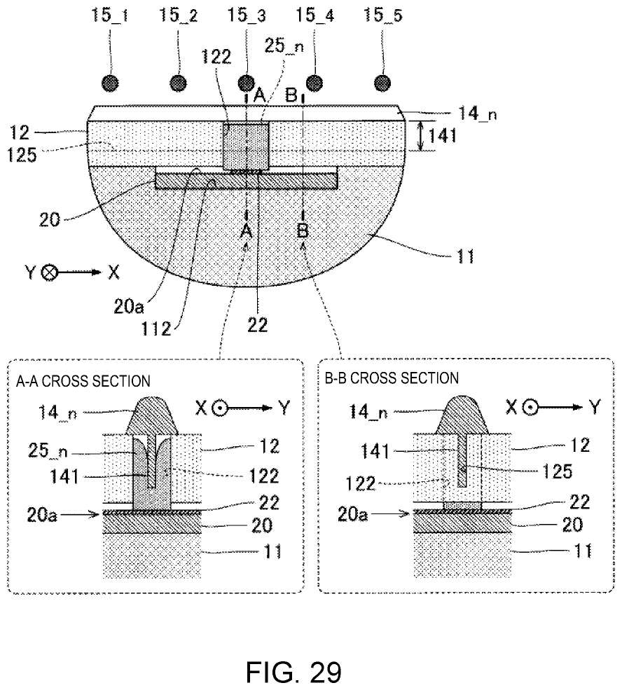

FIG. 29 is a cross-section diagram of the neck 11 and the fingerboard 12 according to the fifth embodiment. A cross section perpendicular to the direction in which the neck 11 extends (Y-axis direction), and cross sections taken along the Y-axis direction (cross sections along line A-A and line B-B) are shown side by side in FIG. 29.

As illustrated in FIG. 29, the projecting portion 141 of each of the frets 14_n in the fifth embodiment is a flat plate-shaped leg portion that protrudes toward the neck 11 and the fingerboard 12 from the bottom surface of the portion of the fret 14_n that extends in the X-axis direction, and extends in the X-axis direction between both ends of the fret 14_n. That is, the projecting portion 141 of the fifth embodiment is continuous over the entire width direction of the fret 14_n.

On the other hand, in addition to the same mounting hole 122 as that of the first embodiment, a mounting groove 125 corresponding to each of the frets 14_n is formed on the surface of the fingerboard 12. The mounting groove 125 is a bottomed groove that extends in the X-axis direction over the entire width direction of the fingerboard 12. The mounting hole 122 is formed in the center of the mounting groove 125 in the X-axis direction. The gap of the mounting groove 125 (gap in the Y-axis direction) is smaller than the gap of the mounting hole 122.

As illustrated in FIG. 29 as a cross section taken along line B-B, the fret 14_n is fixed to the fingerboard 12 as a result of the projecting portion 141 being inserted into the mounting groove 125. That is, one side surface of the projecting portion 141 comes in contact with one inner wall surface of the mounting groove 125, and the other side surface of the projecting portion 141 comes in contact with the other inner wall surface of the mounting groove 125.

As illustrated in FIG. 29, in the fifth embodiment, the connection part 24_n in each of the above-mentioned embodiments is replaced with a connection part 25_n. The connection part 25_n is a flexible conductor that can be deformed by external force. For example, a conductive foam coated obtained by coating, with a conductive film, the surface of a foam body made of an elastic material such as polyurethane can be used as the connection part 25_n.

Similar to the first embodiment, the mounting hole 122 corresponding to each of the frets 14_n is formed on the fingerboard 12. The connection part 25_n is inserted into the mounting hole 122. The lower surface of the connection part 25_n comes in contact with the mounting surface 20a of the wiring substrate 20, and is electrically connected to the feedback line 22 on the mounting surface 20 a. Since the connection part 25_n is deformable, the planar shape of the mounting hole 122 can be freely selected. For example, in addition to a configuration in which the mounting hole 122 that is rectangular in plan view is formed, it is also possible to conceive of a configuration in which the mounting hole 122 that is elliptical or oblong in plan view is formed on the fingerboard 12.

As illustrated in FIG. 29 as a cross section taken along line A-A, the central portion of the projecting portion 141 of the fret 14_n located on the inner side of the mounting hole 122 presses against the top surface of the connection part 25_n. The connection part 25_n is locally deformed by being pressed by the projecting portion 141. Specifically, the projecting portion 141 bites into the connection part 25_n. Accordingly, the connection part 25_n is held in a state of being compressed between the projecting portion 141 and the wiring substrate 20. The lower surface of the connection part 25_n can be bonded to the mounting surface 20a by a conductive bonding material, but does not need to be bonded to the mounting surface 20a.

In the fifth embodiment, the fret 14_n and the wiring substrate 20 (feedback line 22) are electrically connected by the flexible connection part 25_n that is deformed by being pressed by the projecting portion 141. Accordingly, for example, even in a case where there is a positional or dimensional error in the fret 14_n, the fret 14_n can reliably be made to make electrical connection with the feedback line 22.

In addition, the projecting portion 141 for fixing the fret 14_n to the fingerboard 12 is also used for the electrical connection between the fret 14_n and the feedback line 22. Accordingly, there is the advantage that a fret of a conventional string instrument in which the projecting portion 141 extends across the entire width direction of the fret 14_n can be used in the present disclosure.

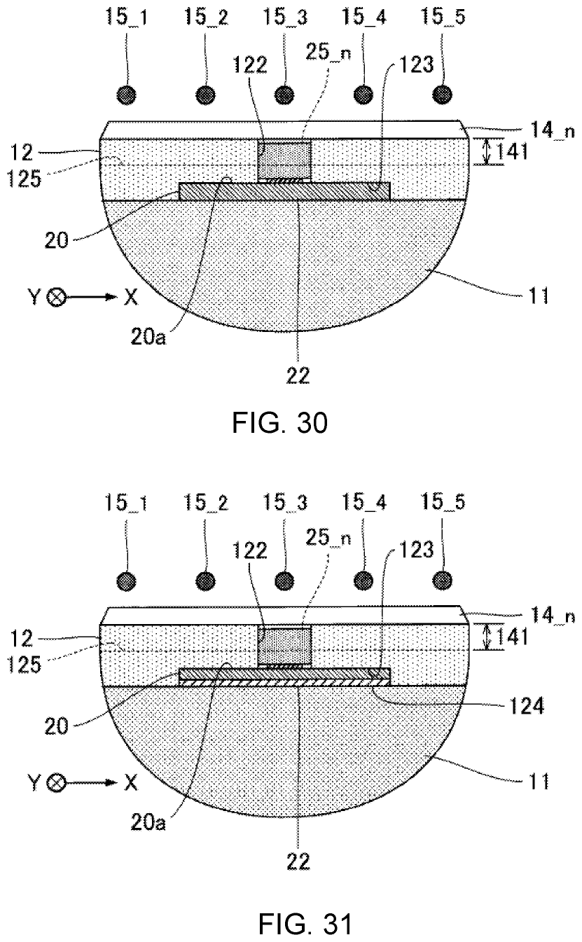

FIG. 29 shows a configuration in which the wiring substrate 20 is housed in the groove 112 formed on the neck 11, but, as illustrated in FIG. 30, the wiring substrate 20 can be housed in the groove 123 formed on the fingerboard 12. In the configuration of FIG. 30, the surface of the neck 11 that faces the fingerboard 12 is a flat surface from which the groove 112 has been omitted.

In addition, in a configuration in which the wiring substrate 20 is housed in the groove 123a of the fingerboard 12, a support member 124 that closes the opening of the groove 123 can be further installed, as illustrated in FIG. 31. The support member 124 is a plate-shaped member (insert) that is formed to have the same shape as the groove 123 in plan view. The wiring substrate 20 is located between the support member 124 and the bottom surface of the groove 123 in the fingerboard 12. The support member 124 can include a plurality of support pieces that are spaced apart from each other in the longitudinal direction (Y-axis direction) of the groove 123. Each support piece is a member that extends in the X-axis direction between the side walls.

### E: Modified Example

Specific modified embodiments to be added to each of the embodiments exemplified above are illustrated below. Two or more embodiments arbitrarily selected from the following examples can be appropriately combined insofar as they are not mutually contradictory.

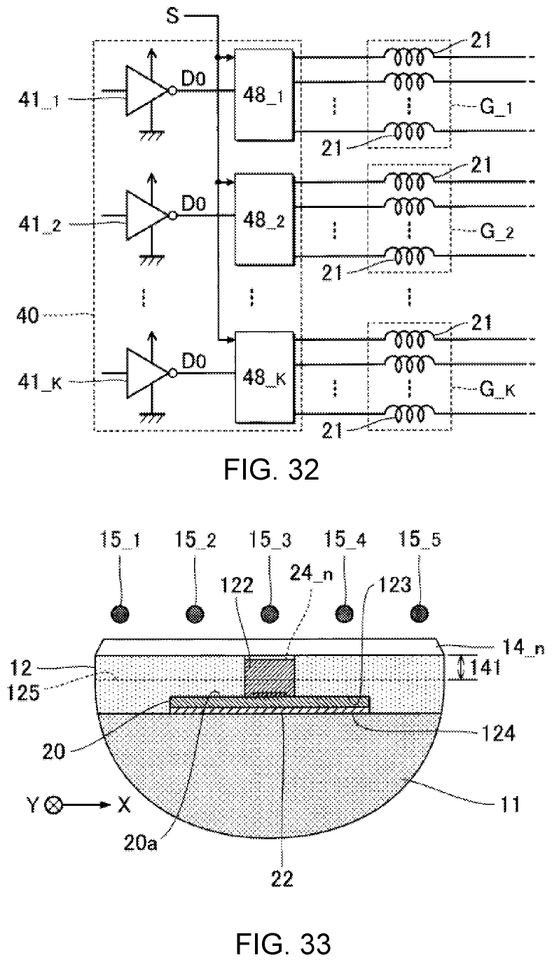

(1) In each of the embodiments described above, an example was presented in which the signal supply unit 40 includes the drive circuit 41_n for each of the drive coils 21_n, but the configuration of the signal supply unit 40 is not limited to the example described above. For example, the signal supply unit 40 illustrated in FIG. 32 can be employed.

In FIG. 32, a plurality (N) of drive coils 21 are grouped, in units of a prescribed number, into K sets (hereinafter referred to as “drive coil groups”) G_1 to G_K. The number of the drive coils 21 belonging to each drive coil group G_k (k=1 to K) can be different. The signal supply unit 40 includes a drive circuit 41_k and a distribution circuit 48_k for each of the K drive coil groups G_1 to G_k.

The selection signal S in FIG. 32 is a control signal for sequentially selecting each of the K drive coil groups G_1 to G_k on a time-division basis. Each of the K drive coil groups G_1 to G_k is sequentially selected in accordance with the selection signal S at each selection period. The drive circuit 41_k outputs the drive signal D0 during the selection period in which the drive coil group G_k is selected. In addition, during the selection period in which the drive coil group G_k is selected, the distribution circuit 48_k outputs, on a time-division basis, the drive signal D0 to each of the plurality of drive coils 21 belonging to the drive coil group G_k. According to the configuration of FIG. 32, the number of drive circuits 41_k can be reduced compared to the above-mentioned embodiments.

(2) In each of the embodiments described above, an example was presented in which the magnetic flux of each of the drive coils 21_n is interlinked with the detection coil 28_m corresponding to each of the five strings 15_1 to 15_5. In the embodiments described above, each of the drive coils 21_n is shared by the five strings 15_1 to 15_5. However, the drive coil 21_n can be individually formed for each of the five strings 15_1 to 15_5.

(3) In each of the embodiments described above, an example was presented in which the voltage detection unit 50 compares each of the detection voltages U_m with the reference voltage R, but the function of the voltage detection unit 50 is not limited to the example described above. For example, the function of comparing each of the detection voltages U_m with the reference voltage R or the function of generating the detection voltage U_m corresponding to the detection voltage V_m can be omitted from the voltage detection unit 50. As can be understood from the examples described above, the voltage detection unit 50 can be simply represented as an element that detects the detection voltage V_m.

(4) The shapes and positions of the feedback line 22 and the reference line 23 are not limited to the examples of the embodiments described above. For example, the feedback line 22 can be installed on the mounting surface 20 a of the wiring substrate 20, and the reference line 23 can be installed on the surface on the side opposite to the mounting surface 20a. In addition, the feedback line 22 and the reference line 23 can be installed on separate wiring substrates. The feedback line 22 and the reference line 23 are not limited to conductive patterns, and can be formed of linear conducting wires.

(5) In each of the embodiments described above, an example was presented in which the reference voltage R that is compared with the detection voltage U_m changes in accordance with the number of simultaneously fretted strings, but the reference voltage R can be a fixed voltage. For example, as can be understood from FIG. 16, by setting the reference voltage R to a fixed voltage of about 0.6 to 0.7 V, it is possible to detect the pressing position of each of the strings 15_m even in a case where a plurality of the strings 15_m are fretted in parallel. However, from the viewpoint of detecting the pressing position of each of the strings 15_m with high accuracy in a state in which a plurality of the strings 15_m are fretted in parallel, the above-mentioned embodiments in which the reference voltage R fluctuates in accordance with the number of simultaneously fretted strings are preferred.

(6) Each of the output signals Z_m generated by the voltage detection unit 50 can be used in any manner. For example, performance data that specify the fretting positions of the performer in chronological order can be generated and stored by analyzing each of the output signals Z_m. In addition, musical sounds corresponding to the fretting positions can be reproduced.

(7) In each of the embodiments described above, an example was presented in which the drive signal D is sequentially supplied to each of the frets 14_n from the first fret 14_1 to the Nth fret 14_N, but the order in which the drive signal D is supplied to each of the frets 14_n is not limited to the example described above. For example, the drive signal D can be sequentially supplied to each of the frets 14_n from the Nth fret 14_N to the first fret 14_1. In addition, for example, an operation of sequentially supplying the drive signal D to each of the odd-numbered frets 14_n and an operation of sequentially supplying the drive signal D to each of the even-numbered frets 14_n can be repeated alternately.

(8) In the first embodiment, a configuration (FIG. 8) in which the projecting portion 141 protrudes from the center of the fret 14_n was presented. As illustrated in FIG. 33, even in the first embodiment in which the connection part 24_n (connection terminal or clasp) is used to connect the feedback line 22 and the fret 14_n, the projecting portion 141 can extend in the X-axis direction over the entire width direction of the fret 14_n, in the same manner as in the fourth embodiment. In addition, as illustrated in FIG. 33, the configuration of FIG. 30 in which the wiring substrate 20 is housed in the groove 123 of the fingerboard 12, and the configuration of FIG. 31 in which the opening of the groove 123 is closed by the support member 124, can also be applied to the first embodiment.

(9) In each of the embodiments described above, the electric bass 100 is illustrated as one example of a string instrument, but the string instrument to which the present disclosure is applied can be freely selected. For example, in addition to the electric bass 100, the present disclosure can be applied to electric string instruments such as an electric guitar. In addition, the string instrument to which the present disclosure is applied is not limited to an electric string instrument that electrically or magnetically detects vibrations of each string. For example, this disclosure can be applied to a natural string instrument that produces sounds through resonance in an internal space of the musical instrument body. That is, the present disclosure can be applied to detect and record fretting by a performer in parallel with the normal playing of a natural string instrument. As described above, the present disclosure can be applied to any type of string instrument that includes frets 14_n that come in contact with strings 15_m due to a performer's fretting.

(10) In each of the embodiments described above, a configuration in which the number of the strings 15_m is five was presented for the sake of convenience, but the number of the strings 15_m can be freely changed in accordance with the type of the string instrument, for example. In addition, the present disclosure is also applied to string instruments such as mandolins in which a plurality of pairs of strings 15_m are installed, each pair being two strings 15_m that are played in parallel with each other.

### F: Addendum

For example, the following configurations can be understood from the embodiments exemplified above.

A string instrument according to one aspect (aspect 1) of the present disclosure comprises a neck, a plurality of conductive frets arranged at intervals from each other along the neck, a plurality of conductive strings that can contact any of the plurality of frets, a plurality of drive coils respectively corresponding to the plurality of frets, a signal supply unit that supplies a drive signal to each of the plurality of drive coils, a feedback line connected to each of the plurality of frets, and a voltage detection unit that detects a first detection voltage between the feedback line and a first string from among the plurality of strings during a period in which the drive signal is supplied to each of the plurality of drive coils.

In the configuration described above, in response to a drive signal being supplied and current flowing through each of the drive coils, an electromotive force is generated in a detection coil that includes the first string and the feedback line by mutual induction that uses the magnetic field that is generated in the drive coil. Accordingly, from among a plurality of frets, the fret that is in contact with the first string (that is, the fretting position) can be identified by detecting a first detection voltage between the first string and the feedback line. According to the configuration described above, the current that flows through the strings is reduced compared to a configuration in which electromotive force is generated in a drive coil on a fingerboard by mutual induction caused by the supply of drive signals to strings. Accordingly, the fretting position can be detected with high speed and accuracy while suppressing impact on the detection (pickup) of vibrations that are generated in the strings due to the performance.

The “drive signal” is a signal for generating a magnetic field in the drive coil. The drive signal is a periodic signal in which the voltage fluctuates periodically, for example. The drive signal is sequentially supplied to each of the plurality of drive coils.

The “first string” indicates any one string selected from among a plurality of strings of a string instrument, and is not limited to the lowest-pitch string. The number of strings installed on a string instrument can be freely selected. In addition, a “string instrument” is an electric string instrument such as an electric guitar or an electric bass. However, the “string instrument” is not limited to an electric string instrument that electrically or magnetically detects vibrations of strings. That is, this disclosure can also be applied to a natural string instrument that produces sounds through resonance in an internal space of a musical instrument body.

In a specific example (aspect 2) of the first aspect, the feedback line is connected to a portion of the first string located closer to the distal end of the neck than the plurality of frets, and the first detection voltage is the voltage between the feedback line and a portion of the first string located closer to the proximal end of the neck than the plurality of frets. According to the configuration described above, it is possible to detect contact of the first string with any of the plurality of frets over the entire neck.

In a specific example (aspect 3) of aspect 1 or 2, the plurality of strings include a second string, the first string and the second string are connected to the feedback line, and the voltage detection unit includes a first detection circuit that detects the first detection circuit and a second detection circuit that detects a second detection voltage between the second string and the feedback line. According to the aspect described above, the first string and the second string are connected to the feedback line. Accordingly, compared to a configuration in which each of the first string and the second string is connected to a separate feedback line, the configuration of the string instrument can be simplified by reducing the number of feedback lines.

In a specific example (aspect 4) of aspect 3, the magnetic field that is generated in each of the plurality of drive coils is interlinked with a detection coil that includes the first string and the feedback line, and with a detection coil that includes the second string and the feedback line. In the aspect described above, the drive coil is shared between the detection coil including the first string and the feedback line and the detection coil including the second string and the feedback line. Accordingly, compared to a configuration in which a drive coil is installed separately for each string, the configuration of the string instrument can be simplified by reducing the number of drive coils. Moreover, since the first and second strings are connected to the feedback line, the size of the drive coil can be reduced compared to a configuration in which the first and second strings are connected to different feedback lines.

In a specific example (aspect 5) of aspect 3 or 4, the instrument further comprises a first resistive element connected between the feedback line and a portion of the first string located closer to the distal end of the neck than the plurality of frets, and a second resistive element connected between the feedback line and a portion of the second string located closer to the distal end of the neck than the plurality of frets. According to the aspect described above, since a resistive element is connected between the feedback line and each of the first and second strings, the impedance of the detection coil is ensured, and the discrepancy in the impedance between the first and second strings can be reduced.

In a specific example (aspect 6) of any one of aspects 1 to 5, the instrument further comprises a fingerboard installed on the neck, wherein the plurality of frets are installed on the fingerboard, the fingerboard is located between the first string and the feedback line, and the plurality of drive coils are located between the fingerboard and the feedback line. In the aspect described above, the plurality of drive coils are installed between the fingerboard and the feedback line. That is, the plurality of drive coils are not exposed to the outside. Accordingly, the drive coils can be installed while maintaining the external appearance of the fingerboard.

In a specific example (aspect 7) of aspect 6, the instrument includes a wiring substrate installed between the neck and the fingerboard, and a plurality of connection parts installed on the surface of the wiring substrate; the plurality of drive coils and the feedback line are installed on the wiring substrate; each of the plurality of frets includes a projecting portion that is inserted into the fingerboard; and each of the plurality of connection parts is connected the projecting portion of, from among the plurality of frets, the fret corresponding to the connection part. According to the aspect described above, the projecting portion that is inserted into the fingerboard in each fret is connected to a connection part of the wiring substrate. Accordingly, each of the frets and the feedback line can be electrically connected by a simple configuration that does not require wiring.

In a specific example (aspect 8) of aspect 7, each of the plurality of connection parts is a flexible conductor that is deformed by being pressed by the projecting portion. According to the aspect described above, the plurality of frets and the feedback line are electrically connected by a conductor compressed by pressure from the projecting portion. Accordingly, even in a case where there is a positional or dimensional error in a given fret, the fret can reliably be made to make electrical connection with the feedback line.

In a specific example (aspect 9) of any one of aspects 1 to 8, the instrument further comprises a reference line that does not contact the plurality of frets, the reference line extends along the neck and is connected to the feedback line, and the voltage detection unit: detects a reference voltage between the reference line and the feedback line, and compares the first detection voltage and the reference voltage. In the aspect described above, the reference voltage fluctuates together with the first detection voltage, in accordance with the number of strings that come in contact with the fret in parallel. Accordingly, the first detection voltage and the reference voltage can be compared to thereby identify, with high accuracy, the fret that is in contact with the first string, regardless of the number of strings that are in contact with the fret in parallel.

In a specific example (aspect 10) of aspect 9, the reference voltage fluctuates in accordance with the number of strings that are fretted from among the plurality of strings. In the aspect described above, the reference line is installed such that the reference voltage fluctuates in accordance with the number of, from among the plurality of strings, the strings that are being fretted. Accordingly, as described above, it is possible to identify, with high accuracy, the fret that is in contact with the first string, regardless of the number of strings that are in contact with the fret in parallel.

In a specific example (aspect 11) of any one of aspects 1 to 10, the instrument further comprises a fretting analysis unit that identifies the fretting position on the first string in accordance with changes in the first detection voltage detected each time the drive signal is supplied. According to the aspect described above, the fretting position can be identified with high accuracy.

In a specific example (aspect 12) of any one of aspects 1 to 11, a prescribed DC voltage is applied to each of the plurality of strings, and the instrument further comprises a fretting determination unit that, in accordance with the voltage of each of the plurality of strings, determines the presence/absence of fretting on the string. According to the aspect described above, it is possible to accurately determine, in accordance with the voltage of each of the strings to which the DC voltage is applied, the presence/absence of fretting on each string.

In order to electrically or magnetically identify, from among a plurality of frets, a fret that is in contact with the string, a configuration for electrically connecting the plurality of frets to wiring is required. In consideration of such circumstances, a string instrument according to one aspect (aspect A) of this disclosure comprises a neck, a fingerboard installed on the neck, a plurality of conductive frets arranged on the fingerboard at intervals from each other, a plurality of conductive strings that can contact any of the plurality of frets, and wiring connected to each of the plurality of frets.

In a specific example (aspect B) of aspect A, the instrument includes a wiring substrate installed between the neck and the fingerboard, and a plurality of connection parts installed on the surface of the wiring substrate; the wiring is installed on the wiring substrate; each of the plurality of frets includes a projecting portion that is inserted into the fingerboard; and each of the plurality of connection parts is connected to the projecting portion of, from among the plurality of frets, the fret corresponding to the connection part. According to the aspect described above, the projecting portion that is inserted into the fingerboard in each fret is connected to a connection part of the wiring substrate. Accordingly, each of the frets and the wiring can be electrically connected by a simple configuration that does not require wiring.

In a specific example (aspect C) of aspect A, each of the plurality of connection parts is a flexible conductor that is deformed by being pressed by the projecting portion. According to the aspect described above, the plurality of frets and the wiring are electrically connected by a conductor compressed by pressure from the projecting portion. Accordingly, even in a case where there is a positional or dimensional error in a given fret, the fret can reliably be made to make electrical connection with the wiring.

What is claimed is:

1. A string instrument comprising:
a neck;
a plurality of frets that are conductive and arranged, along the neck, with an interval between adjacent frets of the plurality of frets;
a plurality of strings that are conductive and are configured to contact one or more of the plurality of frets;
a plurality of drive coils corresponding to the plurality of frets, respectively;
a signal supply unit configured to supply a drive signal to each of the plurality of drive coils;
a feedback line connected to each of the plurality of frets; and
a voltage detector configured to detect a first detection voltage between the feedback line and a first string of the plurality of strings during a period in which the drive signal is supplied to each of the plurality of drive coils.

2. The string instrument according to claim 1, wherein
the feedback line is connected to a portion of the first string located closer to a distal end of the neck than the plurality of frets, and
the first detection voltage is a voltage between the feedback line and a portion of the first string located closer to a proximal end of the neck than the plurality of frets.

3. The string instrument according to claim 1, wherein
the plurality of strings include a second string,
the first string and the second string are connected to the feedback line, and
the voltage detector includes
a first detection circuit configured to detect the first detection voltage, and
a second detection circuit configured to detect a second detection voltage between the second string and the feedback line.

4. The string instrument according to claim 3, wherein
a magnetic field that is generated in each of the plurality of drive coils is interlinked with a first detection coil that includes the first string and the feedback line, and interlinked with a second detection coil that includes the second string and the feedback line.

5. The string instrument according to claim 3, further comprising
a first resistive element connected between the feedback line and a portion of the first string located closer to a distal end of the neck than the plurality of frets, and
a second resistive element connected between the feedback line and a portion of the second string located closer to the distal end of the neck than the plurality of frets.

6. The string instrument according to claim 1, further comprising a fingerboard installed on the neck, wherein
the plurality of frets are installed on the fingerboard,
the fingerboard is located between the first string and the feedback line, and
the plurality of drive coils are located between the fingerboard and the feedback line.

7. The string instrument according to claim 6, further comprising a wiring substrate installed between the neck and the fingerboard, and
a plurality of connection parts installed on a surface of the wiring substrate,
the plurality of drive coils and the feedback line are installed on the wiring substrate,
the plurality of frets include projecting portions, respectively, the projecting portions are inserted into the fingerboard, and
the plurality of connection parts are connected to the projecting portions of the plurality of frets, respectively.

8. The string instrument according to claim 7, wherein
each of the plurality of connection parts is a flexible conductor, and
the plurality of connection parts are deformed by being pressed by the projecting portions, respectively.

9. The string instrument according to claim 1, further comprising a reference line that does not contact the plurality of frets, wherein
the reference line extends along the neck and is connected to the feedback line, and
the voltage detector is configured to detect a reference voltage between the reference line and the feedback line, and compare the first detection voltage and the reference voltage.

10. The string instrument according to claim 9, wherein
the reference voltage fluctuates in accordance with the number of strings that are fretted from among the plurality of strings.

11. The string instrument according to claim 1, further comprising
an electronic controller including at least one processor configured to identify a fretting position on the first string in accordance with changes in the first detection voltage detected each time the drive signal is supplied.

12. The string instrument according to claim 1, wherein
a prescribed DC voltage is applied to each of the plurality of strings, and
the string instrument further comprises an electronic controller including at least one processor that is configured to determine a presence or absence of fretting on the plurality of strings in accordance with a voltage of each of the plurality of strings.
